(19) United States
(12) Patent Application Publication
(10) Pub. No.: US 2014/0351364 A1
(43) Pub. Date: Nov. 27, 2014

(54) SYSTEM, METHOD, AND APPARATUS FOR USING A VIRTUAL BUCKET TO TRANSFER ELECTRONIC DATA

(71) Applicant: Einar ROSENBERG, Miami, FL (US)

(72) Inventor: Einar ROSENBERG, Miami, FL (US)

(21) Appl. No.: 14/455,553

(22) Filed: Aug. 8, 2014

Related U.S. Application Data
(63) Continuation-in-part of application No. 14/191,338, filed on Feb. 26, 2014.
(60) Provisional application No. 61/863,529, filed on Aug. 8, 2013.
(60) Provisional application No. 61/769,680, filed on Feb. 26, 2013.

(51) Int. Cl. H04L 29/08; H04B 5/00

(52) U.S. Cl. CPC H04L 67/1097; H04B 5/0031
USPC 709/213

(57) ABSTRACT

A system that enables a mobile communication device to transfer data to or from a computer system using communication data read from an NFC tag. The first device transfers the data which is temporarily held until the second device removes the data. Once the data is removed, the location where the data was temporarily held is emptied.

### CROSS REFERENCE TO RELATED APPLICATIONS

This application claims the benefit of U.S. provisional patent application No. 61/863, 529, filed Aug. 8, 2013, the disclosure of which is incorporated herein by reference in its entirety. This application is a continuation-in part of U.S. patent application Ser. No. 14/191,338, filed Feb. 26, 2014, which claims the benefit of U.S. provisional patent application No. 61/769,680, filed Feb. 26, 2013, the disclosures of which are incorporated herein by reference in their entirety.

### BACKGROUND

As time progresses, more and more people are using electronic computing devices, e.g., computing systems, desktop computers, laptop computers, computers linked to cloud servers, tablets, mobile computing devices (e.g., mobile communication devices or smart phones), and other types of computing systems. Recently, electronic computing devices include appliances—with the advent and inclusion of “Smart” technology into appliances, electronic computing devices can also include TV's, refrigerators, AC/heating system controls, clothes washers/dryers, and the like.

Electronic data, e.g., information or file(s), are saved on a user's computing device and at some point in the future, it is inevitable that the user desires to transfer or share the electronic data to another computing device, either belonging to him or to another. The electronic data can be any type of electronic document or file, including, but not limited to, music, images, documents, identification information, information, and the like.

There currently exist many different methods to transfer electronic data from one computing system to another system. Each method has its characteristics, which play out as advantages or disadvantages. When a user desires to transfer electronic data wirelessly, additional considerations come into play, for many the most significant issue, aside from the establishing of the communication between the computing systems, is security for the transfer so that electronic file is safe guarded from source computer device to destination computer device.

One communication method for wirelessly transferring files from one computer system to another is Near Field Communications (“NFC”). NFC has an operating range of one to two centimeters, thus, two devices communicating using NFC method need to be very close together. NFC is a type of close proximity communication methods. More and more mobile communication devices are incorporating short distance communication capabilities, mostly near field communication (“NFC”) capabilities. NFC is a short distance wireless communication technology designed for three core capabilities: The first is peer to peer connection, where two NFC devices can communicate with each other. The second is card emulation, where the NFC device can emulate an NFC card. The third is NFC Tag Read/Write, where the NFC device can read from or write to an NFC tag. An NFC tag is a type of close proximity identification medium that can be uncoupled or have a coupled connection to a computer system.

The mobile communication device uses a close proximity communication method such as NFC, to read the tag and receive the unique dynamic ID of an NFC tag. An NFC reader is example of a coupled connection. Transferring data using NFC between mobile communication devices is relatively simple and relatively secure due to inherent requirement of the devices having to be located very close to each other.

To date most computer systems—computer systems that are not mobile communication devices—do not include NFC capabilities; thus, at the very least, the computer system must have an NFC device connected to that computer system in order to communicate using NFC. Adding NFC to a computer system can be costly. Additionally, adding an NFC device can be difficult to employ; for example, in situations where a physical environment restricts setting up a connected device that may require a coupled connection or power between the NFC device and the computer system. Thus, it can be more complicated for a non-mobile computer system without built-in NFC capabilities to securely transfer data via NFC.

Other methods of wirelessly communicating between a computer system and a mobile communication device would require multiple steps that lack the simplicity of NFC communications. Communication Methods, such as sending an e-mail or connecting via a local network connection to a user's device, require a multi-step pairing process.

For example, when completing a visit to a Doctor's office, a person is provided the opportunity to schedule their next appointment. The traditional method of receiving the scheduled appointment from the office is to receive a little card that has written the time and date of the next appointment. As the current method to add a digital entry into a phone has a user manually entering all of the details of the appointment data into phone it is neither uncommon nor unexpected that an appointment card gets lost before the person adds the appointment to their personal calendar. This approach also demands the use of paper products that could be saved. It would generally be easier to wirelessly receive the calendar data and then select an option to save it into the user's phone's calendar system. Traditional methods of digitally sending this data to a phone are complex, Where the user would have to either give the person providing the schedule the user's e-mail address or they would have to pair wirelessly to some network or cloud based system, which can take multiple steps, and be vulnerable to security issues.

Therefore, it would be desirable to have a relatively simple to employ, reasonably low cost, reasonably secure method of wirelessly transferring/sharing electronic data between two electronic computing devices.

### BRIEF DESCRIPTION OF THE DRAWINGS

The accompanying drawings, which are incorporated in and form part of the specification, illustrate embodiments of the invention and, together with the description, serve to explain the principles of the invention. In the drawings:

FIG. 1A depicts an close proximity communication mobile communication device, an close proximity communication Tag, a Computer System communicating to the Virtual Bucket System running on a server or computer system;

FIG. 1B depicts the computer system communicating to the server and depositing data into Virtual Bucket;

FIG. 1C depicts an close proximity communication mobile communication device reading server communication instructions and security identifier information from an close proximity communication Tag;

FIG. 1D depicts an close proximity communication mobile communication device using the server communication instructions to link to the server and send the security identifier as well as close proximity communication mobile communication device user identifier to the server;

FIG. 1E depicts the server confirming the close proximity communication Tag Identifier and the close proximity communication mobile communication device User Identifier and then withdrawing the data or files held in the Virtual Bucket and transmitting the data to the close proximity communication mobile communication device;

FIG. 1F depicts the server confirming to the computer system that the data deposited were withdrawn and to whom they were transferred to;

FIG. 2 depicts a process flow chart corresponding to the flow depicted in FIGS. 1A-F;

FIG. 3A depicts a computer system communicating to a server a request to have close proximity communication mobile communication device deposit requested data into a computer system's virtual bucket;

FIG. 3B depicts a close proximity communication mobile communication device communicating to an close proximity communication Tag and receiving instructions and security identifier for computer system's Virtual Bucket;

FIG. 3C depicts the close proximity communication mobile communication device communicating to the server the close proximity communication Tag security identifier and the close proximity communication mobile communication device Users security Identifier as well as receiving instructions of which data the computer system is requesting from the mobile communication device to be deposited in the Virtual Bucket;

FIG. 3D depicts the close proximity communication mobile communication device depositing data that the user wishes to send or that the computer system has approved from the request of data that computer system requested;

FIG. 3E depicts server communicating to the computer system that the data requested from user have been received;

FIG. 3F depicts the computer system withdrawing the data and/or files from the Virtual Bucket;

FIG. 4 depicts a process flow chart corresponding to the flow depicted in FIGS. 3A-F;

FIG. 5A1 depicts an close proximity communication Tag with a unique security identifier, a First User close proximity communication mobile communication device, and a Server synchronized with knowledge of the specific unique security identifier for that specific close proximity communication Tag;

FIG. 5A2 depicts an close proximity communication Tag with a dynamically changed unique security identifier, a Next User close proximity communication mobile communication device, and a Server synchronized with the knowledge of the newly created unique security identifier for that specific close proximity communication Tag;

FIG. 5B1 depicts a First User close proximity communication mobile communication device communicating to an close proximity communication Tag, and receiving communication instructions to the server and the close proximity communication Tags current unique security identifier;

FIG. 5B2 depicts the First User close proximity communication mobile communication device communicating to the server the unique security identifier while still communicating to the close proximity communication Tag;

FIG. 5B3 depicts the server generating a new unique security identifier for that specific close proximity communication Tag;

FIG. 5B4 depicts the server communicating the newly created unique security identifier to the specific close proximity communication Tag by using the close proximity communication mobile communication device as a conduit; and

FIG. 5B5 depicts a Next User close proximity communication mobile communication device and an close proximity communication Tag and Server synchronized with the newly created security identifier information.

FIG. 6A-C is a depiction of an exemplary approach of the invention.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a relatively simple to employ, reasonably low cost, reasonably secure method of wirelessly transferring/sharing electronic data between two electronic computing devices.

The invention discloses a method for transferring/sharing data between a first electronic computing device—the providing electronic computing device, e.g., a first user's desktop/server/institutional computer system or a mobile communication device, and a second electronic computing device, e.g., a second user's desktop/server/institutional computer system or a mobile communication device—the receiving electronic computing device, by way of an intermediate computing system. More specifically, the invention discloses a method of using a unique identifier, a mobile communication device that can read the identifier, a computer system and a virtual bucket to enable the wireless transfer/sharing of electronic data between the providing device and the receiving device using the virtual bucket as a conduit and a temporary storage location for the electronic data as the electronic data travels between the first and the second computing devices. In an aspect, the unique identifier dynamically changes over time and with use.

In an aspect, a virtual bucket is a temporary intermediary storage location, preferably in a third party's computing system, which temporarily stores the electronic data to be exchanged, substantially right at or near the moment of exchange. The location is temporary as it is holds the data only long enough to have the electronic data provided to the receiving computing system. When the virtual bucket is “emptied” by the receiver, i.e., the information is provided to the receiving user's electronic computing device and the computing system that contains the virtual bucket, e.g., the virtual bucket computing system, deletes the information—the contents of the virtual bucket. Ideally, after the virtual bucket computing system deletes the contents of the virtual bucket, the virtual bucket computing system overwrites the memory location that stored the information with other information so the information is substantially not only permanently deleted (e.g., erased), but the memory location for which any information held for the virtual buck is, ideally, continually overwritten by new and/or different information, thereby essentially making the information permanently deleted, whereby the information cannot be thereafter retrieved from the storage location.

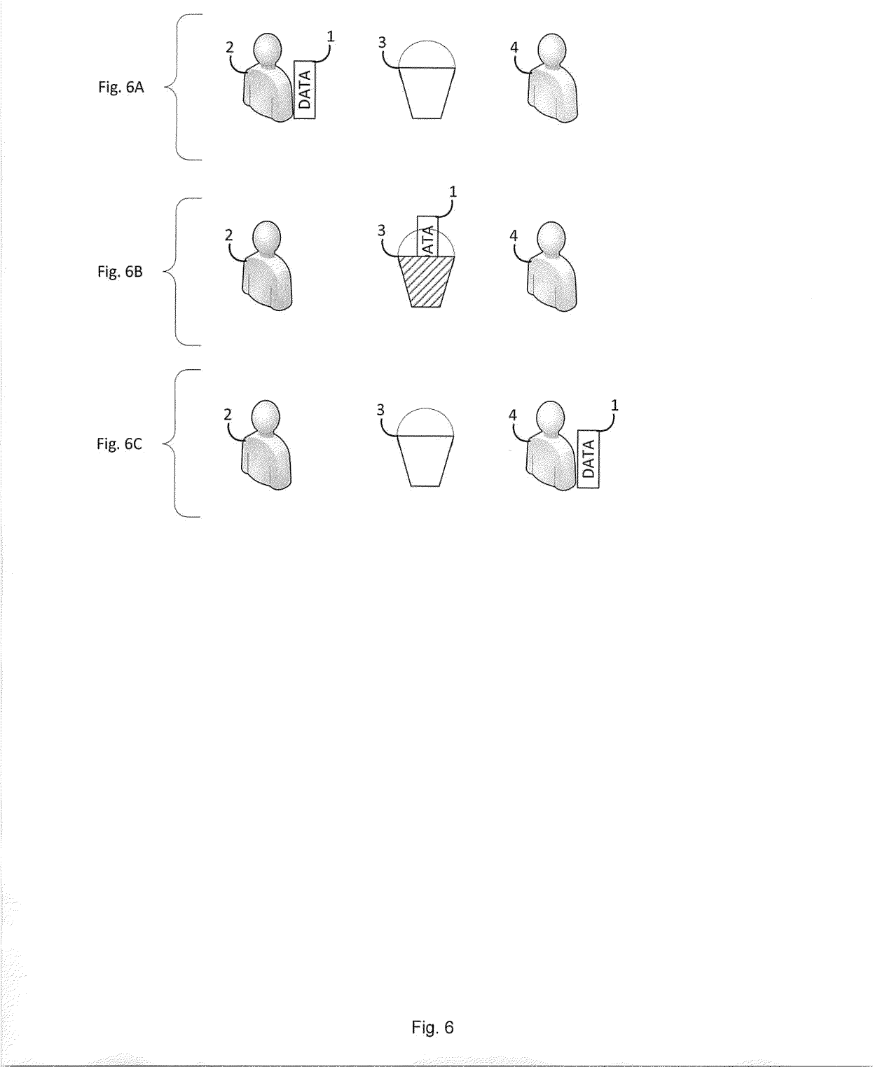

In a very basic premise of the invention, as depicted in FIG. 6A, a first party 2, a providing party, has some data 1 that the first party wants to transfer to/share with a second party 4, a receiving party. First party 2 uses an intermediary, a bucket 3, to provide the data 1 to the second party 4. Preferably, the bucket 3 is empty, as depicted by the un-shaded bucket, prior to data 1 being placed into the bucket 3. As depicted in FIG. 6B, the first party 2 places the data 1 into the bucket 3, as indicated by the data 1 being in the bucket 3, and as depicted by the bucket now being shaded. Subsequently, as depicted in FIG. 6C, the second party 4 receives the data 1 from the bucket 3. The bucket 3 has been emptied as depicted by the bucket being un-shaded. Thus, the data 1 has been transferred or shared from the first party 2 to the second party 4. Although the invention may be disclosed with respect to the use of certain terminology which suggests which device or system creates actions, the invention is not so limited. For example, the invention may describe a device A providing data to a device B, which suggests that device A is substantially performing the actions. In many instances, the action can also be described as device B receiving and/or retrieving data from doing

More specifically, an embodiment of the invention discloses a method of using an NFC Tag, an NFC enabled mobile communication device, and one or more additional computer systems and/or server(s), to allow a computer system or the NFC enabled mobile communication device, to deposit, temporarily, electronic data into a virtual bucket of a computing computer system(s) or server(s). The NFC enabled mobile communication device reads, using NFC communications, communication instructions from the NFC Tag, to enable the NFC enabled mobile communication device to communicate, using the communication instructions, generally using a second communication method, to a location of a computing system where the electronic data is stored e.g., a virtual bucket, for downloading the electronic data to the mobile communication device. Upon communicating to the computer system that includes the virtual bucket, the NFC enabled mobile communication device can withdraw or deposit information and/or the Smartphone can retrieve the data being stored in the virtual bucket which was stored there by the computer system or a second computer system. In an aspect, the computer system can also request data from the NFC enabled mobile communication device and withdraw such data from the virtual bucket, once a NFC enabled mobile communication device deposits them into a computer system's virtual bucket for retrieval by another computer system. Although generally described with respect to a NFC system, the invention is not limited and generally refers to close proximity communication systems, including, but not limited to NFC, short range bluetooth, and other visual and audible communication systems.

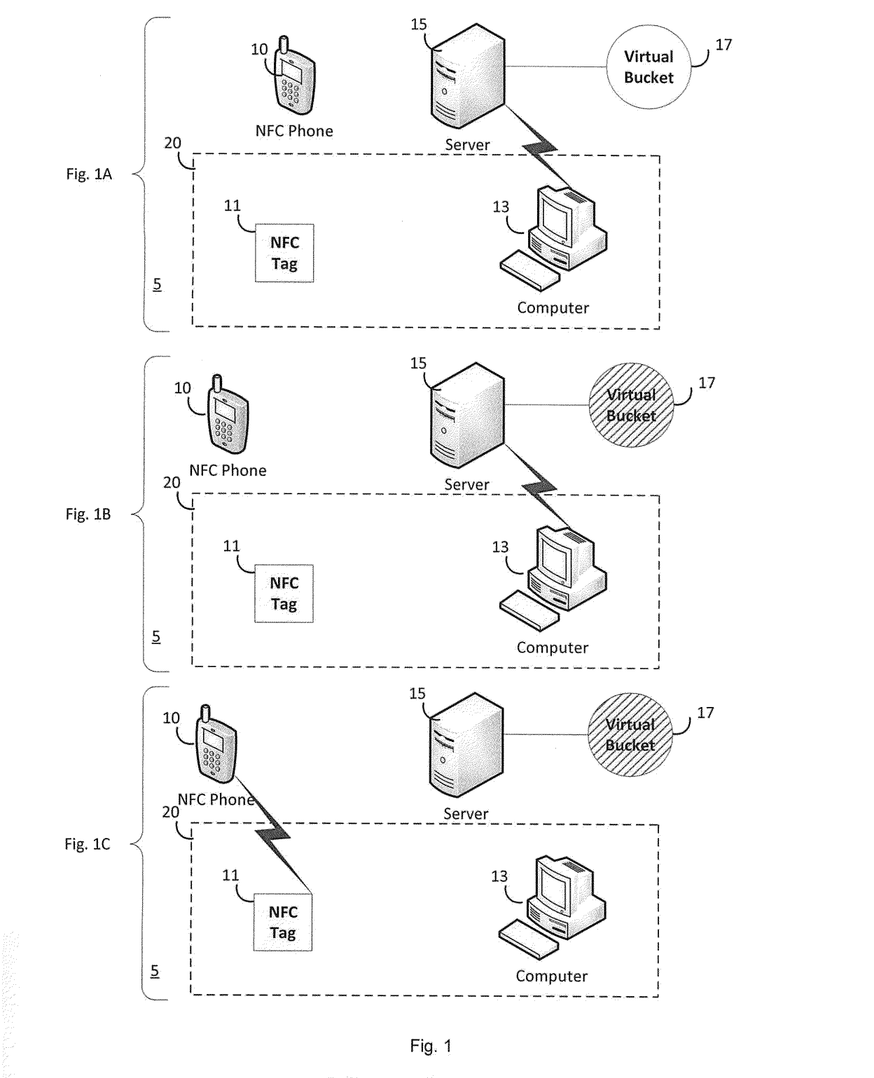

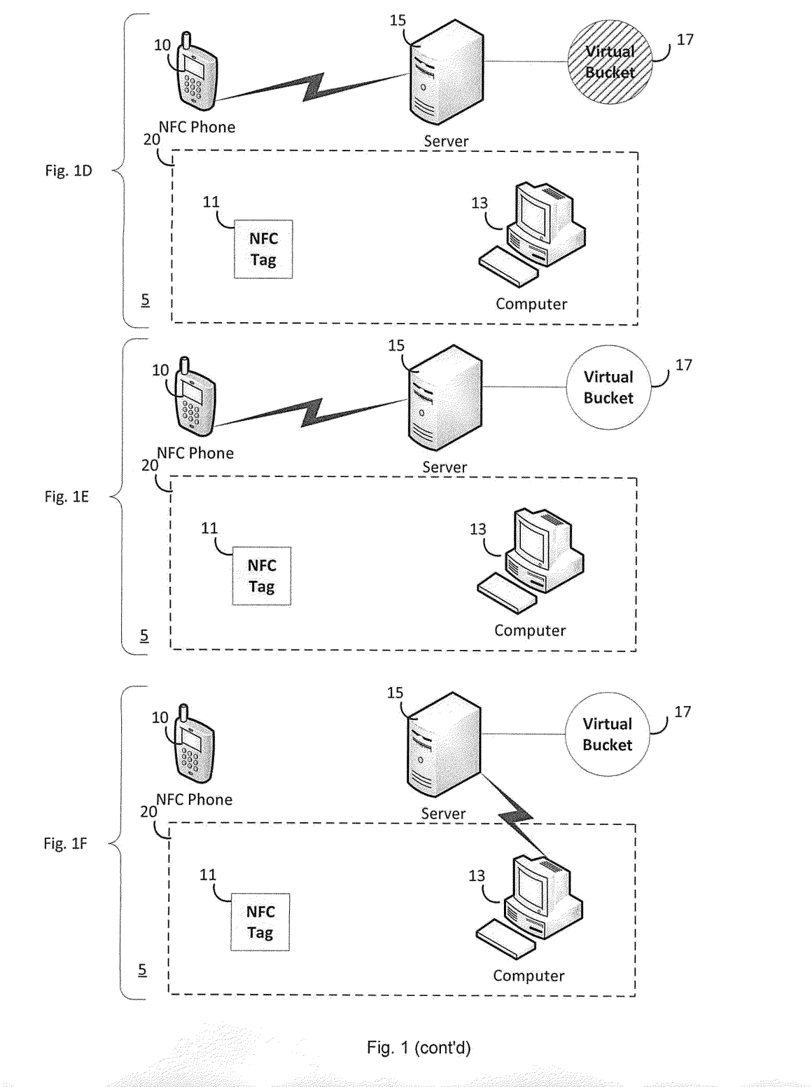

FIG. 1A discloses a data transfer system 5 and method in accordance with an exemplary embodiment of the invention using a virtual bucket system. The system 5 includes a close proximity communication enabled mobile communication device 10, an information source 20 which includes a close proximity communication enabled transfer description data source 11, and a computer system 13, and a computer system 15 which includes a storage area 17, e.g., a virtual bucket. In a first aspect, the device 10 is the receiver of information and the computer 13 is the provider of the information. In a second aspect, the device 10 is the provider of information and the computer 13 is the receiver of the information.

In a preferred approach, mobile communication device 10 is a close proximity communication enabled mobile communication device such as a Mobile Computer Processing Device, including but not limited to a Mobile Phone (a “smart phone”), Tablet, Laptop, etc. In an exemplary approach, a close proximity communication enabled mobile communication device 10 is an NFC enabled mobile communication device. The mobile communication device 10 includes at least two communications capabilities: close proximity communications and a second, different communication method. The first communication method is, for example, NFC communications. The second communication method is, for example, Wi-Fi, Bluetooth, Cellular, Wireless USB, Ethernet, or any other wireless or wired communication method which enables the mobile communication device 10 to communicate with a server and/or computer processing device, including but not limited to a mobile phone (including a Smartphone), tablet, laptop, etc., system(s) 15.

In an approach, communications between a tag 11 and a device 10 are done through close proximity communications, e.g., near field communications, and other communications between other devices is generally done through communications other than close proximity communications, e.g., secondary communications methods described above. Although the invention is described as using near field communications, the invention is not so limited and any communication system can employed; however, in a preferred approach close proximity communication methods are preferred for communications between the mobile communication device 10 and a transfer description data source 11. In another aspect, the second communication method is a hardwired communication method.

While the invention references the use of NFC, other technologies may be substituted general modifications of some capabilities of the invention. These other technologies can include, but are not limited to 2D Barcodes, Bluetooth, Wi-Fi, etc. While the invention discloses an NFC Tag, an NFC Device can also be used such as an NFC Reader which is stand alone, connected to another computer system, or able to communicate with the server(s) or computer system(s) via network connection.

In an aspect, the mobile communication device 10 is running an appropriate program, e.g., a Virtual Bucket app for a mobile communication device, for the context of the device and the context of use, e.g., electronic data exchange with another computing system using a virtual bucket. Although generally referred to as an app, this is a general reference to a software program and can be and generally is referred to by several different names, e.g., an app, program, application, plug-in, etc., that, for all intents and purposes, achieves the same desired goal. The virtual bucket app on the mobile communication device 10 performs and/or causes the mobile communication device 10 to perform the actions necessary to transfer electronic data to a virtual bucket or from a virtual bucket. The Virtual Bucket app effectuates transferring electronic data from the mobile communication device 10 to an identified virtual bucket 17 for transfer to another computing system 15. In another aspect, the Virtual Bucket app effectuates transferring electronic data to the mobile communication device 10 from an identified virtual bucket 17 which received the data from to another computing system 13.

In operation, the virtual bucket app on the mobile communication device 10 causes the of reading data from an NFC tag, interpreting the data, acting on the data, communicating with a server 15, and transferring data from/to the virtual bucket of server 15. In an aspect, when the data has been received from the virtual bucket 17, the app confirms (with the user) of the mobile communication device 10 that the data should be stored and determines where to store the data or request information from the user. For example, the app identifies what kind of data file has been received and depending on the type of data file, the Virtual Bucket app saves the data in a particular location. For example, if the Virtual Bucket app identifies data received as a calendar entry for a particular calendar system (e.g., Google, yahoo, etc) on the user's mobile communication device 10 and when approved for storage by the user, the Virtual bucket causes the stores the data in the storage area for that calendar system. Different types of data are generally stored in a location specific for that type of data.

In an approach, a user manually selects the Virtual Bucket app to run on the mobile communication device 10. In another approach, the user touches—places the mobile communication device within sufficient distance of another close proximity device in order to carry out communications—the mobile communication device 10 to the NFC tag 11 which initiates NFC communications using the inherent NFC capability of the mobile communication device 10 as well as the NFC tag 11.

If the virtual bucket app is not already installed on a mobile communication device 10, a user can download and install it from a public program server, e.g., Apple app store, Google Playstore, Microsoft server. Alternatively, the virtual bucket app is downloaded automatically. As part of initial communications, the mobile communication device 10 receives data from the NFC tag 11. Part of the data received from the NFC tag 11 indicates an appropriate program that should be running on the mobile communication device 10, e.g., the Virtual Bucket app for a mobile communication device. In a preferred approach, the mobile communication device's 10 operating system looks for the Virtual Bucket app on the mobile communication device 10, and if it isn't already executing, then using another part of the data received from the NFC tag 11, the operating system, alone, or in combination with other aspects of the mobile communication device 10, determines where to download the Virtual Bucket app from and causes the Virtual Bucket app to be downloaded, installed and executed on the mobile communication device 10.

In an aspect, the Virtual Bucket app on the mobile communication device 10 uses part of the data received from the NFC tag 11 to determine what to do. For example, the Virtual Bucket app receives communication information providing information on how to communicate with the server 15 to access data in the Virtual bucket 17. For example, the communication information is a URL or web site address of the server 15. The communication information may also contain a preferred communication method for communicating with the server 15. For example, a preferred communication method is the Internet. In an aspect, the communication information includes access information, e.g., a username and password, to access the Virtual Bucket. Thus, using the communication information the Virtual Bucket app causes the mobile communication device 10 to establish communications with the server 15.

In an aspect, the Virtual Bucket app on the mobile communication device 10 uses part of the data received from the NFC tag 11 to identify the appropriate virtual bucket 17 of the server 15. In an aspect, tag 11 stores a unique identifier which is provided to the device 10. In turn, device 10 provides that unique identifier to the server 15. The server 15 uses the unique identifier to identify which virtual bucket 17.

As noted above, an information source 20 includes a transfer description data source 11, e.g., a tag, and a computer system 13. In a preferred approach, the information source 20 is the source of the electronic data sought to be transferred to the mobile communication device 10. More specifically, the computer system 13 includes the electronic data sought to be transferred to the mobile communication device 10. Although depicted as a single information source 20, single tag 11 and computer system 13, the invention is not so limited, and the system 5 can have a plurality of information sources 20, tags 11, and computers systems 13. Preferably, especially when there is a plurality of tags 11, identifying information stored on a tag 11 uniquely identifies the respective tag 11.

In an aspect, a method of using a dynamic unique security identifier (“USI”) on a close proximity tag 11, e.g., an NFC Tag, is also provided and discussed in greater detail below. A Mobile close proximity communication Device reads from a tag the USI and server/computer system communication instructions. The USI maps to a unique virtual bucket for access by the Mobile close proximity communication device. Similarly, a computer system also maps to the unique virtual bucket for access to the virtual bucket. In an aspect, the relationship between the tag/virtual bucket/computer system is only maintained for a single transaction. After the transaction, the virtual bucket is deleted and a new virtual bucket created for association with the tag and computer system, but having a different USI, the tag 11 also creates a different USI that corresponds to the USI of the computer 13. By virtue of being dynamic, the USI allows for enhanced security in at least two different ways: firstly, it reduces the possibility of the NFC Tag being impermissibly cloned, which the computer server uses to know which virtual bucket corresponds to the computer system defined to that NFC Tag. Secondly, by virtue of having a dynamic association, it reduces the probability of a third party impermissibility seeking and accessing the virtual bucket thereby increasing the security of the system. In an aspect, a USI is relatively anonymous and thus increases the security of the system.

The computer system 13 includes an appropriate program, e.g., a Virtual Bucket program for a computer system or server, which is executed on the computer system 13. When executing, a user on the computer 13 indicates to the program which data, e.g., a music, text, audio, video, calendar entry, contact, task, memo, etc, file is desired to be transferred to another party's computing system, e.g., mobile communication device 10. The computer system 13 has an associated virtual bucket 17 residing within a server 15. Although described as a single bucket corresponding to a computer system 13, the invention is not limited and in another approach, there is a plurality of virtual buckets 17 associated with a computer system 13. The program on the computer system 13 causes the data selected by the user to be copied and the copy sent to the server 15 with appropriate instructions that it should be placed in the virtual bucket 17 of the server 15.

In an approach, computer system 13 maintains identification information for a virtual bucket 17 associated with computer system 13. As such, when sending data is stored in a virtual bucket, the computer system 13 also sends virtual bucket identification information so that the server 15 is able to determine which virtual bucket the data is to be placed in. In an aspect, the server 15 uses the virtual bucket identification information to determine which virtual bucket computer system 13 is referring to.

In an aspect, the NFC Mobile Device User and the Computer System user are securely logged in or registered to the virtual bucket system. The mobile device, server, or computer system can act as the receiver or sender of the information and/or files being placed in the virtual bucket. The mobile device user can also request specific information and/or files from the computer system, for the computer system to deposit the requested information and/or files into the virtual bucket of the computer system.

In a preferred aspect, transfer description data source 11 includes at least several pieces of data that will be read by a mobile communication device 10 appropriate program designation data, communication data, access data, and identifying data. One piece of data to be read by the mobile communication device 10 is program designation data. This data indicates the appropriate program, e.g., the Virtual Bucket app, that a mobile communication device 10 should be executing to implement data transfer using a Virtual bucket. This data also indicates where the appropriate program can be located, e.g., downloaded from.

In an aspect of the invention, tag 11 includes access information. In certain situations, where increased security protocols are employed, a mobile communication device 10 may require additional information to access and retrieve data in a virtual bucket. For example, the additional information is a password or passcode that is provided to the server 15 to access the data in the virtual bucket. Thus, the mobile communication device 10 reads this information from the tag 11 and provides the access information to the server 15 when the mobile communication device 10 communicates with the server 15 to access the virtual bucket 15. In an aspect, tag 11 includes identifying information. In an aspect, the identifying information identifies the tag 11. The identifying information is, for example, a unique serial number for tag 11. In another aspect, the identifying information is USI. In another aspect, the identifying information is information that reflects a unique association between the tag 11 and a storage location. In an aspect tag 11 executes an application or API of the virtual bucket system on the tag 11 which provides additional features and interactions with the mobile communication device 10.

In an aspect the server 15 including the virtual bucket 17 is a general public service such as Gmail or Facebook or Amazon server, and then people will sign up online to setup an account. That will then allow them to either download an app to their computer or they can run it via a web portal. They will be issued an NFC tag corresponding to that account, use a program to encode a blank NFC tag, or get a pre-encoded NFC tag for an account and then using the information from that NFC tag, will link it to an existing account or create an account based on that pre-encoded tag. In an aspect, the identifying information of the tag 11 received from the mobile communication device 10 is used by the computer server 1 to determine the account. In an aspect, this account is literally the virtual bucket and the corresponding dynamic id that is created, e.g., the id is address information for part, e.g., folder, of the account that will hold information, e.g., the bucket. Once they have the account on the server, and the NFC tag encoded to link to that account, the NFC mobile communication device simply uses the app installed on the phone, which they registered their own account, and processes the methods as described in the flow charts below. In another aspect, the server 15 including the virtual bucket 17 is a non-public, higher security, dedicated, partially or totally, server In an exemplary approach, the virtual bucket deletes the data being held upon a command. In another approach, the virtual bucket is designed to securely hold the information till the next person that securely communicates to the server and new data is transferred to the virtual bucket for downloading.

Server 15 manages the bucket 17. Consequently the server 15 has and/or provides rules on how to manage the bucket 17. Server 15 may be associated with the user of device 10 or may be associated with computer system 13 or not associated with either computer system and may be an independent system. Depending on the association determines who ultimately is the manager of the virtual bucket. For example, in a retail environment, e.g., the dentist office scenario discussed below, the virtual bucket is likely associated with the retail business, e.g., the dentist's office. The manager can provide rules for managing the virtual bucket. The server 15 executes a virtual bucket program on the server 15 that when executing manages at least one virtual bucket in its memory. The management includes enabling a first device to access and upload data to be stored in a memory location (e.g., identified by the communication data), storing the data, and enabling a second device to access and download data stored in the memory location (e.g., identified by the communication data). In an aspect, instructions of the virtual bucket program of the server 15 includes a method for determining what server, location of server, instructing a method of communication such as using Bluetooth or Wi-Fi to communicate with a localized device such as the computer system being nearby, or on the same network as the mobile device will communicate by. The instructions of the virtual bucket program of the computer 15 can also have instructions to how communicate; for example, app to app, where the app on the phone is instructed on how to communicate with the app on the computer system. This is akin to setting up a virtual private network. The instructions can also include additional security aspects such as an RSA key, a public/private key encryption, etc. The instructions are instructions, and can vary, but at the end, are designed to tell the phone where and how to communicate to the computer system holding the virtual bucket.

The server 15 maintains a linking database, which maintains the relationship information between computer systems, e.g., computer system 13, and virtual buckets, e.g., virtual bucket 17. The linking database also maintains the relationship information between tags, e.g., identification information of a NFC tag 11, and virtual buckets, e.g., virtual bucket 17. In an aspect, the later database is based on USI. The server 15 uses these databases to determine the appropriate memory location for the computer system 13 and the appropriate memory location corresponding to identification information of a NFC tag 11.

In an exemplary approach, the virtual bucket 17 deletes the data being held in the virtual bucked after the data has been requested and provided to the mobile communication device 10 so that no copy of the data remains on the server 15, e.g., the server deletes the virtual bucket 17 and any data contained therein. The server 15 then creates a new virtual bucket 17 having a new USI associated with it and updates its internal linking databases and in certain aspects conveys, directly or indirectly the USI for the new virtual bucket preferably to computer system 13 and NFC tag 11, respectively. In another approach the virtual bucket 17 deletes the data being held in the virtual bucked upon receiving a command so that no copy of the data remains on the server 15. In another approach, the virtual bucket 17 securely holds the data in the virtual bucket 17 until new data is transferred to the virtual bucket for downloading. In a preferred approach, the actual location of the virtual bucket in the storage area of computer system 15 changes from one storage of information to the next storage of information, the computer system 15 determines the current location of the virtual bucket in the storage area of computer 15. After information has been provided from the virtual bucket to a receiving computer system, the storage area corresponding to the virtual bucket is overwritten with non-significant data. When another request for storing data is received, preferably a new location in its memory is used to store the new data and the computer system 15 tracks the new memory location so that it locate it when needed. In an aspect, after the file has been requested and transferred out of the virtual bucket and the virtual bucket and the information it contained has been deleted by the computer server, if a party subsequently requests a file from the deleted virtual bucket, then the subsequent requesting is notified by the server, in some form or fashion, that the file is no longer available.

Although depicted as a single virtual bucket 17, the invention is not so limited, and the server 15 can have a plurality of virtual buckets 17. Further the system 5 only depicts one server 15, the invention is not so limited and the system 5 can have a plurality of servers 15.

In an aspect, the server 15 is a separate computer system from computer system 13. In other aspects, the server 15 is the same as or an associated computer system with computer system 13.

A Virtual Bucket software generally runs in the background or foreground of all devices for the system, including the mobile NFC device 10, NFC Tag 11, computer system 13, and server 15. In an aspect, each of the devices has different hardware and software configuration and therefore an appropriate version of the virtual bucket system will be employed to effectively execute on the hardware/software combination of each device. Once installed and operational, the software essentially runs seamlessly in the background without any or without a significant amount of input/interaction from a user to work, with the notable exception of requiring decision input from a user. Although referred to as software, the invention is not so limited and it may also be referred to as an app, plug-in, module, and other various parts of a computing system. Furthermore, the system can also be implemented in hardware.

The virtual bucket app on the mobile communication device 10 communicates with a predefined server 15 or a central switch board on a server, and uses the tag identifier to link to or be redirected to a computer system's Virtual Bucket 17, which may be on that server with the central switch board, or on a second server/computer system. The information may also be in a specified format in which the virtual bucket system on the Mobile Device can read and/or interpret.

The communication instructions received from tag 11 provide instructions to the mobile communication device 10 directing how the mobile communication device 10 can communicate with server(s) 15 including virtual bucket 17 which corresponds to the account linked to the specific NFC Tag 11 being communicated with. The communication instructions include, for example, URL, IP address, port, login process, application to application communication, api to api communication, and other methods of defining one device to a second device to communicate via electronic means.

While the invention references the use of NFC, other technologies may be substituted general modifications of some capabilities of the invention. It would be obvious to one with skill any modifications that would be necessary. For example, while some descriptions of exemplary embodiments of the invention are described with respect to the use of NFC technologies, other close proximity communications technologies can be substituted include, but are not limited to Barcodes (2D, 3D, and otherwise), Bluetooth and Bluetooth beacons, Wi-Fi, LED lights, etc. While the invention discloses an NFC Tag, an NFC Device can also be used such as an NFC Reader which is stand alone, connected to another computer system, or able to communicate with the server(s) or computer system(s) via network connection. In another approach, if communication method other than NFC is being employed, then an appropriate corresponding device is employed in place of an NFC tag. In an aspect, the server 15 is a separate computer system from computer system 13. In other aspects, the server 15 is the same as or an associated computer system with computer system 13.

FIG. 1A depicts a computer 13 communicating with server 15 as represented by the lightning symbol connecting computer 13 and server 15. As part of this communicating, the computer 13 provides access data, e.g., secure account access information, to server 15 and once authorized, is allowed to deposit information and/or files into a virtual bucket 17 within server 15. Ideally, bucket 17 is a specific, discrete location within server 15 that “belongs” to computer 13. Computer system(s) and/or Server(s) virtual bucket 17 system can be an file location or an application, stand alone or integrated into a third party application, which gives third party application virtual bucket capabilities, or can be an API running on the OS, where the API can define a specific storage location folder for the virtual bucket 17. As the virtual bucket 17 has not yet received data from computer system 13, the virtual bucket 17 is “empty” and is not shaded to reflect this status.

The implementation and set up of the virtual bucket system determine how data will be provided to the virtual bucket. Files can be provided from the providing computer system to the virtual bucket automatically. The virtual bucket system on the system that manages the virtual bucket has established when and how data is transferred to the virtual bucket. For example, in a dentist office it is the calendar event that is transferred to a first party via a virtual bucket. Thus, the virtual bucket on a dentist's computer system, computer system 13, is set up to monitor the dentist office appointment system and when a new appointment is added to the dentist calendar, the virtual bucket system takes a copy of a (portion) of the appointment an provides it to the virtual bucket. The patient subsequently accesses the virtual bucket to download the appointment to his electronic device 10.

In another aspect, data is manually provided to the virtual bucket. For example, in a web page example, a user hits a button on the browser page which starts the transfer of information, e.g., the currently displayed web page or a URL to the currently displayed web page to a virtual bucket.

FIG. 1B depicts computer 13 communicating information and/or files that are to be stored in the virtual bucket 17 located or running on the server. In an aspect, the server 15 includes a current unique security identifier for the NFC Tag 11 corresponding to the computer system's 13 virtual bucket 17 running on the server 15. As the virtual bucket 17 has received data from computer system 13, the virtual bucket 17 is not “empty” and is shaded to reflect this status as containing data.

FIG. 1C depicts a mobile communication device 10 wirelessly communicating with tag 11 as depicted by the lightning symbol connecting device 10 and tag 11, thereby requesting and receiving information contained on the tag 11, including, but not limited to, communication instructions from tag 11. The communication instructions provide instructions to the mobile communication device 10 to direct the mobile communication device 10 how to communicate with server(s) and/or computer system(s) 15 running virtual bucket 17 which corresponds to the account linked to the specific NFC Tag 11 being communicated with. The communication instructions include, for example, URL, IP address, port, login process, application to application communication, API to API communication, and other methods of defining one device to a second device to communicate via electronic means. Mobile communication device also receives the unique identifier of the tag 11. In an aspect, the mobile communication device 10 also receives identification information regarding the location or identification of the virtual bucket. In an aspect, the mobile communication device 10 also receives access information.

FIG. 1D depicts mobile communication device 10 communicating with a server as depicted by the lighting symbol connecting device 10 and server 15. In an aspect, mobile communication device 10 uses communication instructions received from the tag 11 to communicate with the server 15. Mobile communication device 10 transmits a unique tag identifier and/or a dynamic, and any instructions, warnings, or requests that may be defined by mobile communication device 10, for example, that it won't accept certain file types, or certain instruction types. For example, if this is an android phone, it won't accept ical invite, it can only process vcal or gcal invites. Ical is specific to iPhone os, so it can instruct the server that it can't accept that file type, or the virtual bucket system on the mobile communication device 10. Additionally, for example, if the system is sending a request of specific data or files that the phone is to send to the virtual bucket, then the phone user can define things it doesn't want to send. For example, the system is requesting the user to send their full name, address, phone number, and e-mail. The phone user can define that they will send first name, address and phone number, but not e-mail or last name. The user can always define restrictions or filters of what they are willing to receive from the virtual bucket or give to the virtual bucket. The unique security identifier can be dynamic or a single consistent identifier such as a specific account name of the virtual bucket 17 for the specific computer system 20 that the tag 11 is defined to. In an aspect the mobile communication device 10 transmits secure identifier information of the mobile communication device 10.

FIG. 1E depicts mobile communication device 10 continuing to communicate with a server 15. After server 15 validates the unique tag identifier from tag 11 and secure identifier information of the mobile communication device 10, the server 15 processes any instructions, warnings, or requests. In an approach, the validation follows standard verification and acceptance protocols. It is the general process of establishing a secure method of communicating between a device and remote server/computer. An example of an instructions, warnings, or requests is when the server reacts based on these instructions, warnings, or requests. Example, if the phone doesn't accept ical, but the calendar invite was sent from a mac, the server might have a conversion program to convert the file into a format that is acceptable by the mobile communication device. Another example is that the information is in English, but the user only speaks French, the server can then translate the information based on a user's request. The server 15 determines the virtual bucket 17 sought by the mobile communication device 15 based on identification information. The server 15 withdraws the data currently held in the virtual bucket 17 and transfers them to the mobile communication device 10. As the virtual bucket 17 has provided the data to mobile communication device 10, the virtual bucket 17 is “empty” and is not shaded to reflect that status. In an aspect, The mobile communication device 10 queries its user for approval of the storage of the received data.

FIG. 1F depicts mobile communication device 10 having received data from the virtual bucket 17. In an aspect, the virtual bucket 17 is empty and ready to receive additional information and/or files from computer 13. In another aspect, the virtual bucket 17 still maintains a copy of the information transferred to mobile communication device 10. The server 15 communicates to the computer system 13, confirming the delivery of the information and/or files to the mobile communication device 10 and secure identifier information of the mobile communication device 10 that it was transferred to.

Thus, data is quickly and easily transferred from a computer system to a mobile communication device.

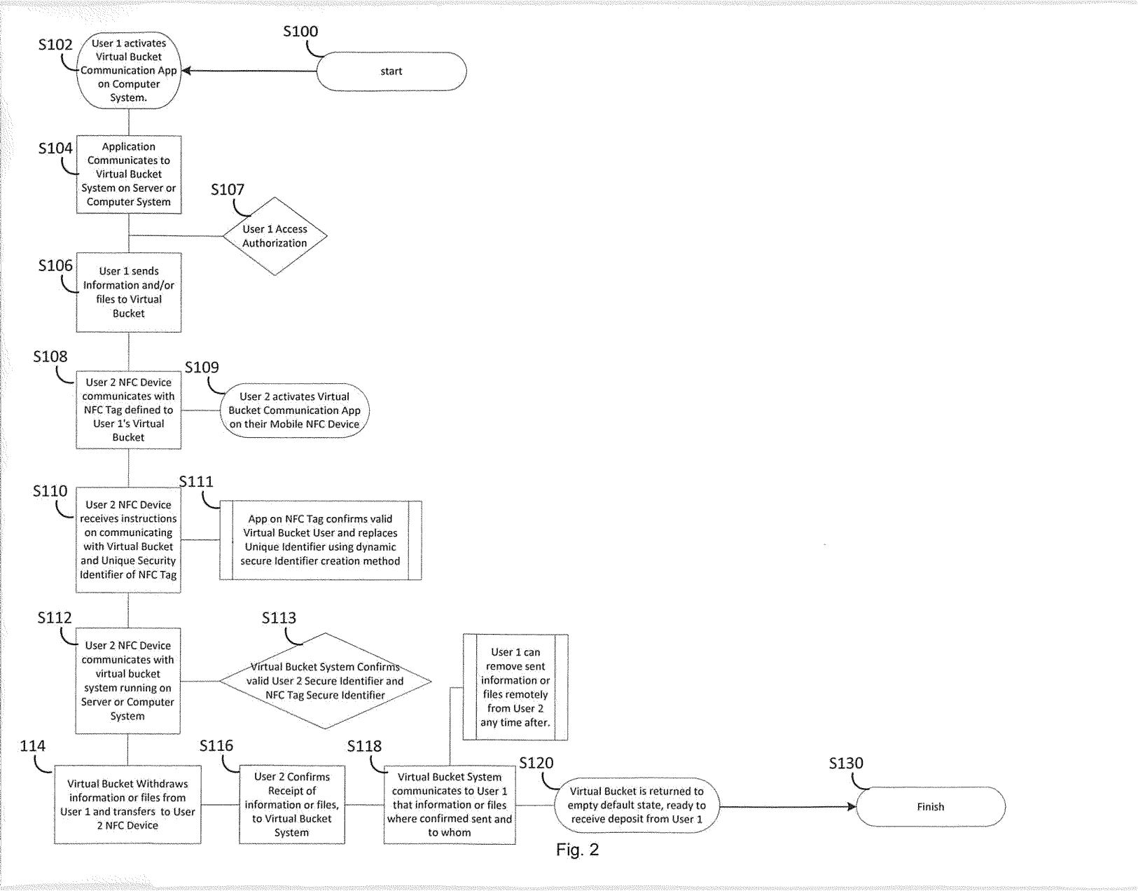

FIG. 2 is a flowchart that depicts an exemplary operation of an aspect of the invention generally in accordance with FIGS. 1A-F. In this exemplary process flow, User 1 corresponds to a user using computer system 13 and User 2 corresponds to a user using mobile communication device 10. (FIG. 1A).

In segment S100, the process flow begins. Process continues to segment S102.

In segment S102, User 1 activates a virtual bucket program on the computer 13. Process continues to segment S104.

In segment S104, the virtual bucket program executing on the computer 13 established communications with server 15. Process continues to segment S106.

In segment S106, User 1 selects data and sends the data to virtual bucket 17 part of server 15. As part of this process, User 1 provides its access information, S107, to the server 15 for access to the virtual bucket 17. If the virtual bucket 17 has not been created yet, then server 15 creates a virtual bucket 17 on server 15. Process continues to segment S108.

In segment S108, User 2 causes his mobile communication device 10 to communicate with NFC tag 11 and download information. Process continues to segment S109.

In segment, S109, if the Virtual Bucket App is not executing on the mobile communication device 10, then the mobile communication device 10 checks to see if the Virtual Bucket App is installed on the mobile communication device 10. If it is installed, then the mobile communication device 10 executes the Virtual Bucket app. If the app is not installed, the mobile communication device 10 uses part of the information from the NFC tag 11 and communicates with an appropriate location, e.g., website, where the app can be downloaded from and downloads and installs the app. Once installed, the mobile communication device 10 causes the app to be executed. Process continues to segment S110.

In segment S110, the virtual bucket App determines based on information received from tag 11 information for communicating with the server 15. The virtual bucket app also determines unique security identifier for the tag 11 based on information received from tag 11. Process continues to segment S111.

In segment S111, in an aspect, an application running on the NFC tag confirms that the mobile communication device 10 is a valid user and replaces unique security identifier with a dynamic secure identifier. Process continues to segment S112.

In segment S112, mobile communication device 10 establishes communication with server 15. Process continues to segment S113.

In segment S113, in an aspect, the virtual bucket program on server 15 confirms that the user, e.g., mobile communication device 10, is a valid user. For example, the virtual bucket program on server 15 confirms the validity based on the EIN number, or some other unique identifier ideally created during an install on the mobile communication device 10. Process continues to segment S114.

In segment S114, the virtual bucket program on the server 15 takes the data from the virtual bucket corresponding to the computer 13 and causes the data to be sent to mobile communication device 10. Process continues to segment S116.

In segment S116, the mobile communication device 10 sends a signal to server 15 and confirms receipt of the data from server 15. Process continues to segment S118.

In segment S118, the server 15 sends a signal to computer 13 indicating User 2 (mobile communication device 10) has received file. In an aspect, at any time, User 1 can remove files from User 2. Process continues to segment S120. In segment S120, server 15 deletes data from virtual bucket 17 and deletes virtual bucket 17. Process continues to segment S130.

In segment S130, the process ends. Thus, data has been transferred from the computer system 13 to the mobile communication device 10.

For example, when completing a visit to a Doctor's office, a person is provided the opportunity to schedule their next appointment. The traditional method of receiving the scheduled appointment from the office is to receive a little card that has written the time and date of the next appointment. As the current method to add a digital entry into a phone has a user manually entering all of the details of the appointment data into phone it is neither uncommon nor unexpected that an appointment card gets lost before the person adds the appointment to their personal calendar. This approach also demands the use of paper products that could be saved. It would generally be easier to wirelessly receive the calendar data and then select an option to save it into the user's phone's calendar system. Traditional methods of digitally sending this data to a phone are complex, Where the user would have to either give the person providing the schedule the user's e-mail address or they would have to pair wirelessly to some network or cloud based system, which can take multiple steps, and be vulnerable to security issues. This method creates a one time, secure access point, designed to know that anyone else is listening or is trying to manipulate the communication. Hence, if bucket is empty when you try to access it, that means someone was accessing it before you.

When considering all the issues of storing information in the cloud, and always routing information to the same IP address, then criminals are provided the same specific point to know where to attack, and you put a dependency on others to protect the transmission and storage of information you are sending. How often have we heard in the media that some trusted company lost millions of peoples information. How often have people been introduce to malware or viruses, because they accessed a specific web address that was hacked or injected, which thereby they thought it was safe to go there, but it was a fake location. For example, a website redirect that looks like a bank website, but in truth is a hacker posing as a certain website. Rather than sending information what you manually put in to a browser that you don't know, is it not more dependable to do it our way, with the virtual bucket. Even if the hacker for example, tries to spoof a bucket, the system is designed to use your phone as part of the confirmation method. So while the tag/barcode/beacon might indicate a specific unique ID, I′m reading it by my phone. My phone has my tightly control virtual bucket app, which communicates to the virtual bucket server. My phone is my phone, but who knows where that other device has been or whose messed with it. My phone I have more control over, so I might ready a unique ID on that device, but my phone is at that point, sending it the virtual bucket server.

The virtual bucket server looks to see if that unique dynamic bucket ID has recently been created and still active. If so, then it uses that bucket as a channel to the correct servers, and if it doesn't recognize that bucket ID, then that's someone else trying to manipulate things. Considering that websites are static, they cannot offer a dynamic identifier. So they are inherently insecure. But our technology creates a new bucket with a new bucket ID for every transaction, and makes it a seamless user experience. So it doesn't matter how many insecure devices are out there, which aren't users and you cannot monitor or control if they are infected. The point is that on that device, you'll only communicate to it if it has a real and valid bucket ID, because if the virtual bucket server tells the phone that the bucket ID it just sent was invalid, then you won't be sending any information from your phone to the bucket. It's a safe, smart, and basically hack proof method of making sure you don't communicate with hacked or vulnerable devices. And even if you do, because it's a one way communication method, with a blind secure middle man, being the bucket, then you cannot be vulnerable to getting your own device hacked. This is not true for basically everything out there today.

Quick example of this. You've probably seen those kiosks where you read a barcode or use Bluetooth to download coupons or a loyalty card into your phone. But when you walk into that store, how do you know that kiosk hasn't been hacked and is going to route your phone to a malicious server, so instead of you downloading coupons, you've downloaded a virus?

With the bucket system, first off, communicating to that device is only too receive a unique dynamic identifier. So if a fake one is read, then it won't be confirmed on the virtual bucket system as a currently active bucket that was just created. A person can spoof a website, and a person can create a Trojan to hack another's phone. But the virtual bucket system makes it basically impossible to spoof anything, and you cannot slip in a Trojan when there isn't dual communication, and that communicate is designed to not let you stream a constant flow of info but instead deposit and withdraw.

Mobile phones are the next step in interacting with the world. And the world is going to have lots of devices that we want our phone to interact with. But while you know and control your phone, you don't know where the other device has been. We know the vulnerabilities are real and out there in a big way. We know the internet of things already out paces the number of computers, tablets, and smart phones combined. How can we trust communicating with anything today, when we don't know where it's been or whom has taken it over. Recently, researchers showed how USB is incredibly vulnerable. Yet we do everything that USB can do, but never worrying about such vulnerabilities.

The invention discloses a relatively simple to employ, reasonably low cost, and reasonably secure method of wirelessly transferring/sharing electronic data between two electronic computing devices.

It is easy to employ the invention as described above with reference to embodiments described and as follows. Virtual bucket software/apps can be easily downloaded and installed on computing systems, including a user's desktop system and a third party's mobile phone by visiting an app store (Apple's, Google's, or Microsoft's) and purchasing, preferably for free or for a nominal fee, downloading and installing the appropriate program or app. The program on the desktop, in a preferably approach, operates in the background and interfaces with many existing applications. For example, instead of sending a message, e.g., an appointment, through an e-mail server, you send it to a Virtual bucket. NFC tags currently are less than a $1.00 per tag and can be easily programmed by a user, generally by using Internet instructions. Another party provides a Virtual bucket, e.g., Creating Revolutions, the company that created Virtual Bucket system, provides a virtual bucket that is used for transactions. In an approach, the user pays a nominal fee per transaction, $0.10 per transaction, and the third party pays nothing.

With respect to the cost saving, it is important to consider two points, the cost of implementing on new devices today, and the cost of implementing to legacy devices. For any manufacturer today, to implement such a comparable secure and intuitive communication method would be extremely costly. It would require RF shielding, an area to implement an antenna for radio frequency communication, integration for some processing and memory to allow intelligent communication, a modification of their current firmware, and more. And this is just for the new devices. The second situation of cost is legacy. Considering your TV has an average lifespan of 7 years, the cost of having consumers wait nearly a generation for the benefit of a new technology is really high. It has a chain reaction to multiple segments of the economy when a certain, poorer group of society has to wait to catch up to the richer segment of society. And the fewer people able to access such a technology creates a slowdown in the growth of that infrastructure. Unlike those two situations of cost, this technology can cost as little as 1 penny to make the basic elements work today, on more than a billion of diverse devices in people's homes and offices right now.

In another aspect, information is transferred from a mobile communication device to a computer system. The operation is similar to that described above with respect to FIGS. 1A-F. In this scenario, the computer system 13 requests specific data or files from the mobile phone 10. In an aspect, the mobile phone 10 does not remove information from the virtual bucket 17 but rather places information in the virtual bucket 17. The information can either be defined by the computer system 13, or it can be defined by mobile phone user 10. The information is then deposited into the virtual bucket 17 associated with the computer system 13. In an aspect, as long as the virtual bucket remains active, data can continue to be deposited and withdrawn using the computer system's virtual bucket account.

In an exemplary approach, multiple things, e.g., three things, can be deposited into a virtual bucket: 1. Info/files deposited by computer system. 2. Request for info/files deposited by computer system. 3. Info/files deposited by phone into computer systems virtual bucket. The third scenario is an extension of the second, but in this case, there were no requests deposited. The mobile phone user simply deposited the info/files into the computer systems virtual bucket and the virtual bucket system informs the computer system that info/files have been deposited into the computer systems virtual bucket account and by whom.

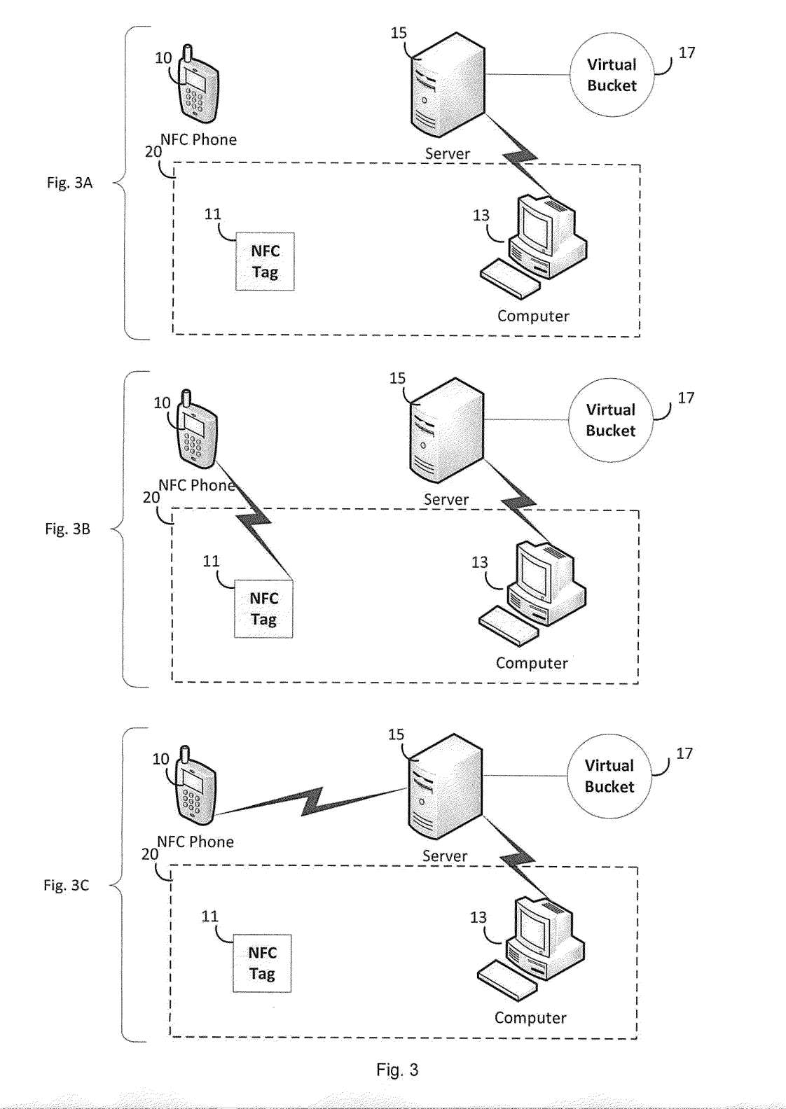

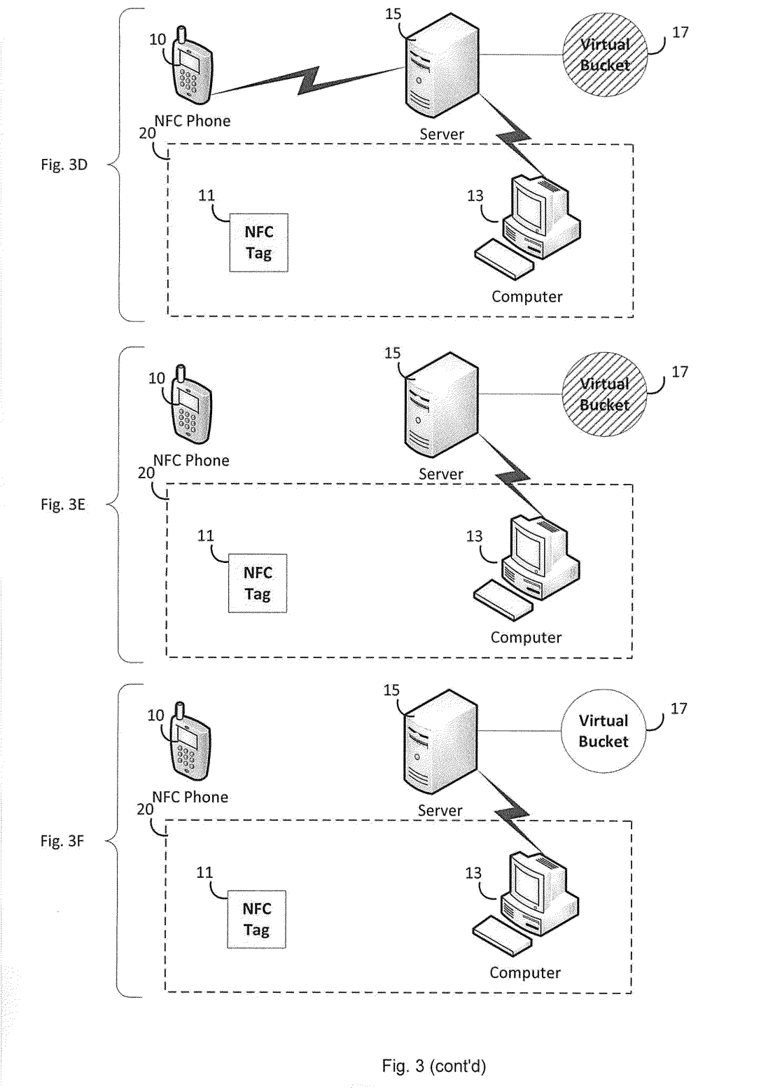

FIG. 3A discloses a data transfer system 105 and method in accordance with another exemplary embodiment of the invention. The system includes a close proximity communication enabled mobile communication device, e.g., a NFC enabled mobile communication device 10, a information source 20 which includes a close proximity communication tag, e.g., an NFC tag 11 and a computer system 13, and a computer system 15, e.g., an Internet connected server, which includes a storage area 17, e.g., a virtual bucket. In this aspect, the computer system 13 requests information from mobile communication device 10.

As depicted in FIG. 3A, the computer system 13 communicates to server 15 and indicates what data, e.g., which information and/or files, it wishes to request from mobile communication device 10. This request can include specific information such as name, e-mail address, Q/A, lists, etc. Files requested can include documents, v-card, voice/video recording, etc. The request is held by the virtual bucket system.

FIG. 3B depicts mobile communication device 10 communicating with tag 11, thereby requesting and receiving communication instructions from tag 11. The communication instructions provide instructions to the mobile communication device 10 to direct the mobile communication device 10 how to communicate with server(s) and/or computer system(s) 15 running virtual bucket 17 which corresponds to the account linked to the specific NFC Tag 11 being communicated with. Mobile communication device also receives the unique identifier of the tag 11.

FIG. 3C depicts mobile communication device 10 communicating with a server 15. Mobile communication device 10 transmits the unique tag identifier, and any instructions, warnings, or requests that may be defined by mobile communication device 10, or the virtual bucket system on the mobile communication device 10. The unique security identifier can be dynamic or a single consistent identifier such as a specific account name of the virtual bucket 17 for the specific computer system 20 that the tag 11 is defined to. In an aspect the mobile communication device 10 transmits secure identifier information of the mobile communication device 10.

Server 15 validates the information and if approved, the server 15 looks at the request in the virtual bucket 17. The server 15 then transmits the request from the bucket 17 to the mobile communication device 10 the request for information or files which the computer system is requesting from mobile communication device 10 user. Virtual bucket system on mobile communication device 10 generally requests its user for the information and/or files.

Example of verification is when the mobile phone user installs the app on their phone, they register for an account. When registering, the app will communicate to the server unique aspects of that user's phone such as the ein number. This will validate that the user is a registered user for the system and that the person is whom they say it is. Unlike traditional methods where one uses a username and password, with this method, one can't have just anyone download the app on another phone and then login using your credentials and pretend it's that person. This method links at first registration, that phone to a unique account for the virtual bucket system. This securely identifies that user based on their first time registered.

Virtual bucket system on mobile communication device 10 can, if the user permits, automatically finds the information and/or files being requested, and list the requested items it found, as well as any items that are missing. If this ability is not activated by user, user will use traditional file search methods to access and locate files being request. For information requests, user can use traditional input methods such as keyboard or voice/video recording to supply the information being requested.

FIG. 3D depicts that after the mobile communication device 10 gathers and/or generates information and/or files requested, and receives approval of the requested information, the mobile communication device 10 transmits the requested information and/or files to virtual bucket 17. Once the server 15 deposits the information in the virtual bucket 17, the server 15 sends mobile communication device 10 confirmation of the receipt of requested items.

FIG. 3E depicts that after the request data is stored in the bucket 17, the server 15 sends notification to the computer 13. In an aspect, the server 15 indicates to the computer 13 an inventory of the data received from mobile communication device 10: what items were received and which items were not, e.g., items not authorized or available by NFC mobile communication device user.

FIG. 3F depicts server 15 withdrawing information and/or files from virtual bucket 17 and transmits them to computer 13. Once computer 13 has received the information and/or files, the virtual bucket 17 is then emptied and ready for further use.

Thus, a computer system has requested data from a mobile communication device and the data has been transferred from a user's mobile communication device to a computer system.

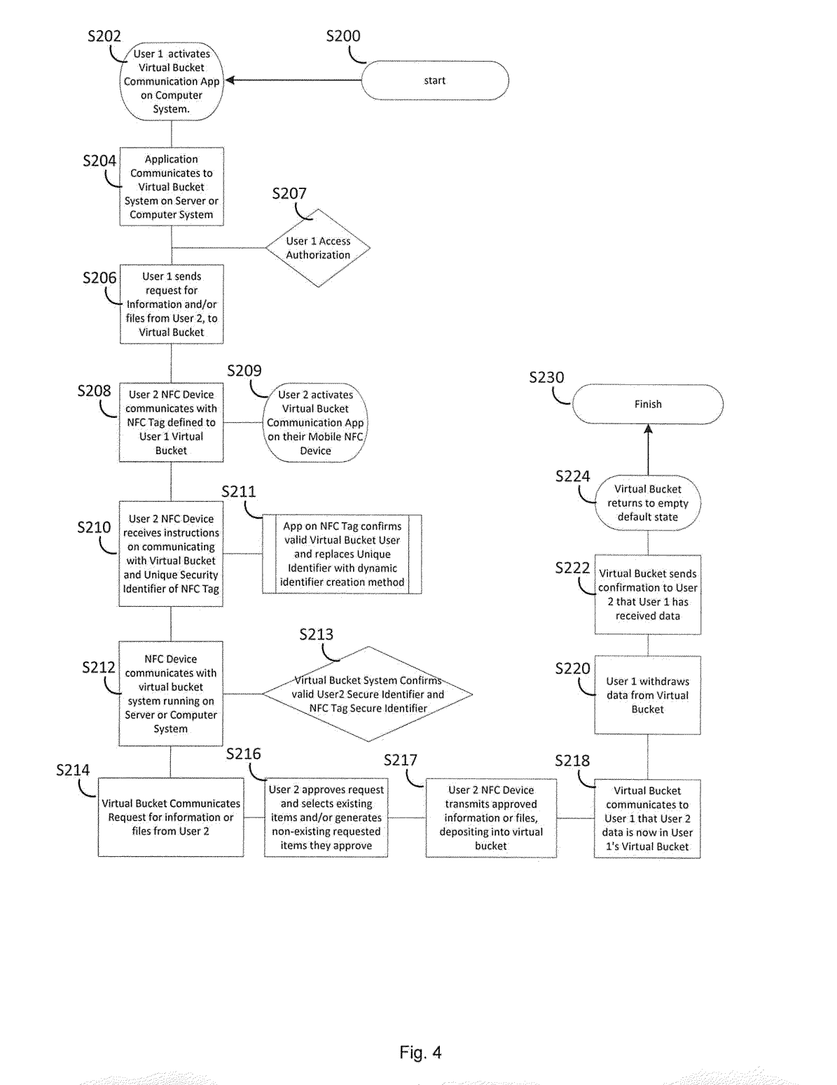

FIG. 4 is a flowchart that depicts an exemplary operation of an aspect of the invention generally in accordance with FIGS. 3A-F. In this exemplary process flow, User 1 corresponds to a user using computer system 13 and User 2 corresponds to a user using mobile communication device 10. (FIG. 3A).

In segment S200, the process flow begins. Process continues to segment S202.

In segment S202, User 1 activates a virtual bucket program on the computer 13. Process continues to segment S204.

In segment S204, the virtual bucket program executing on the computer 13 establishes communications with server 15. Process continues to segment S206.

In segment S206, User 1 sends a request for data from User 2 to virtual bucket 17 part of server 15. As part of this process, User 1 provides its access information, S207, to the server 15 for access to the virtual bucket 17. Process continues to segment S208.

In segment S208, User 2 causes his mobile communication device 10 to communicate with NFC tag 11 and download information. Process continues to segment S209.

In segment, S209, if the Virtual Bucket App is not executing on the mobile communication device 10, then the mobile communication device 10 checks to see if the Virtual Bucket App is installed on the mobile communication device 10. If it is installed, then the mobile communication device 10 executes the Virtual Bucket app. If the app is not installed, the mobile communication device 10 uses part of the information from the NFC tag 11 and communicates with an appropriate location, e.g., website, where the app can be downloaded from and downloads and installs the app. Once installed, the mobile communication device 10 causes the app to be executed. Process continues to segment S210.

In segment S210, the virtual bucket App determines based on information received from tag 11 instructions for communicating with the server 15. The virtual bucket app also determines unique security identifier for the tag 11 based on information received from tag 11. Process continues to segment S211.

In segment S211, in an aspect, an application running on the NFC confirms that the mobile communication device 10 is a valid user and replaces unique security identifier with a dynamic secure identifier. Process continues to segment S212.

In segment S212, mobile communication device 10 establishes communication with server 15. Process continues to segment S213.

In segment S213, the virtual bucket program on server 15 confirms that User 2 is a valid user. Process continues to segment S214.

In segment S214, the virtual bucket program on the server 15 takes the data request from the virtual bucket corresponding to the computer 13 and causes the data request to be sent to mobile communication device 10. Process continues to segment S216.

In segment S216, User 2 goes through the data request and approves or denies each request. For each approved request, User 2 selects data corresponding to the request. Process continues to segment S217.

In segment S217, the mobile communication device 10 transmits the selected data to server 15 to be placed in the virtual bucket 17. Process continues to segment S218.

In segment S218, the server 15 sends a signal to computer 13 indicating to User 1 that the requested data has been received into the virtual bucket 17. Process continues to segment S220.

In segment S220, User 1 causes the virtual bucket program on the computer system 13 to cause the server 15 to send the data in the virtual bucket 17 to computer system 13. Process continues to segment S222.

In segment S222, server 15 sends a signal to User 2 indicating that user 1 has received the data. Process continues to segment S224

In segment S224, server 15 deletes data from virtual bucket 17. Process continues to segment S230.

In segment S230, the process ends. Thus, User 1 has requested data from User 2 and User 2 sent the data to User 1 using a virtual bucket.

Thus, a virtual bucket system can be employed in many different situations to easily transfer information from one computing system to another. For example, in the Doctor's office example described above, instead of getting a card or piece of paper with the next appointment or having to enter the appointment information into the patient's smart phone, an electronic appointment file representing the appointment can be sent from the doctor's office computing system to the patient's Smartphone and saved in the appropriate calendaring program on the phone. The doctor's office generates the appointment and sends it to the virtual bucket. The patient then touches his smart phone to an NFC tag located at the checkout desk of the doctor's office. The patient's Smartphone communicates with the computer system that includes the virtual bucket containing the appointment information and downloads the information from the virtual bucket to the smart phone. the virtual bucket app on the smart phone, either automatically or manually, stores the appointment information in an appropriate calendar location.

In another aspect, a unique identification information changes over time. In the example described above with reference to FIGS. 1A-F, the identification information stored and provided by the NFC tag generally remains the same. In another aspect of the invention, the identification information stored and provided by the NFC tag is dynamic and changes over time.

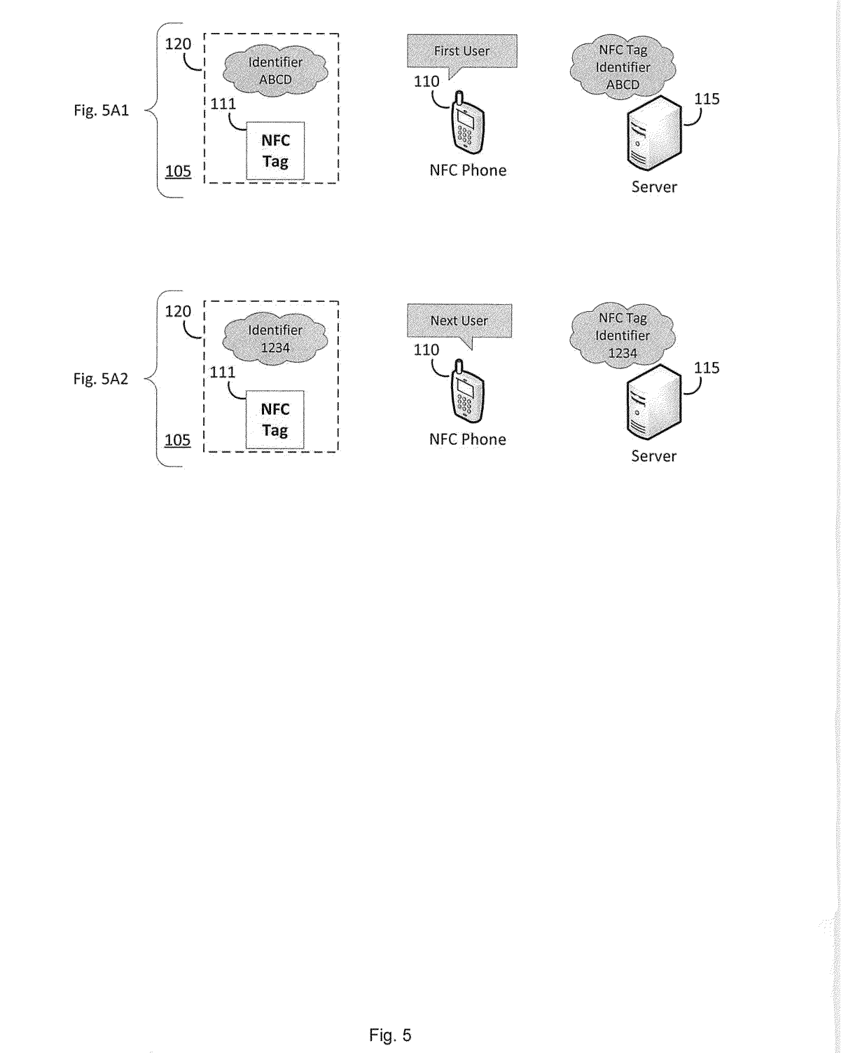

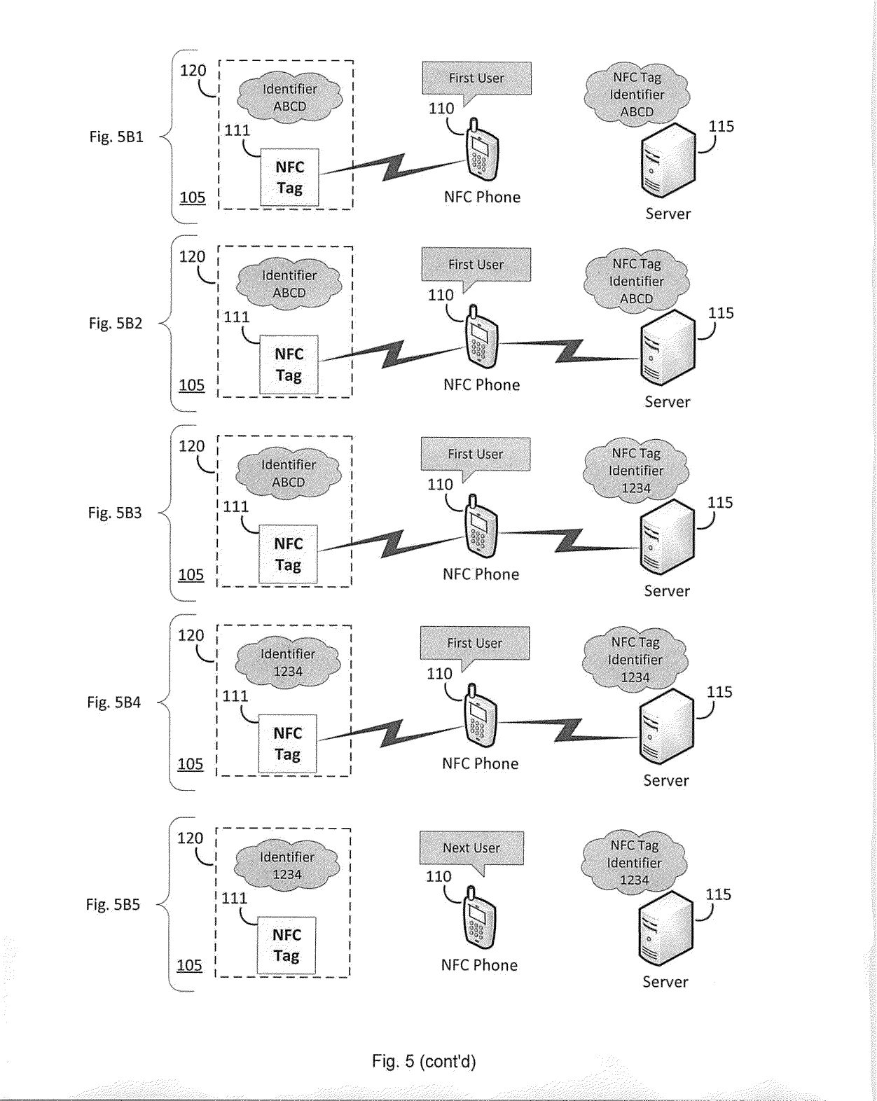

FIG. 5 depict a data transfer system 105 and method in accordance with another exemplary embodiment of the invention using a virtual bucket system. Similar to that depicted with respect to FIG. 1, the system 105 includes a close proximity communication enabled mobile communication device 110, an information source 120 which includes a close proximity communication enabled transfer description data source 111, and a computer system 113 (not pictured for simplicity), and a computer system 15 which includes a storage area 17 (not picture for simplicity), e.g., a virtual bucket. In this embodiment, a dynamic identification system and method is employed.

FIG. 5A1-2 depict an app or process running on a server and separately on a close proximity communication tag, e.g., server 115 and NFC tag 111, respectively. In an aspect, the app, residing and executing on each respective device is used generate security keys on respectively on each. These are synchronized by virtue of their programming and will change after every use of the virtual bucket. Because they are synchronized, they'll have the same corresponding unique identifier at substantially the same time; the unique identifier dynamically changes after every use of the virtual bucket, but each respective identifier will correspond after each change.

For example, an NFC tag 111 is the medium of communicating to a close proximity communication enabled mobile communication device 110 how to communicate to the computer system 113. In an aspect, the tag 111 provides a unique id of the computer system 113. The computer system 113 has also to store a unique id, the same id that is provided by the NFC tag to the mobile communication device 110. When a computer system 113 initially communicates to the server 115, in effect, the computer system 113 is requesting the use of a virtual bucket. When the server 115 creates a virtual bucket 117, the server 115 also creates a unique id to be associated with the virtual bucket 117. The server 115 provides the unique id associated with the virtual bucket it created for the computer system 113. When a virtual bucket transaction is completed, the server 115 eliminates the virtual bucket and its associated id and the server generates a new virtual bucket to be associated with the computer and generates a new bucket id and communicates it back to the computer system 113.

In an aspect, the mobile communication device 110 reads a security key from the tag 111 when reading other information and security key of the tag is compared to the security key of the server 115, generally by the server 115 and generally when the server 115 is validating other information received from the mobile communication device.

In an aspect, the security key of the tag changes dynamically. Thus in an exemplary approach, before an initial use, a NFC tag will have a first security key and the server will have a matching first security key. Thus, the security keys will match. During a first use (and preferably, subsequent uses), when a smart phone reads the NFC tag and connects to the computer system that includes the associated virtual bucket, the computer system validates the security key that the smart phone read from the NFC tag and provided to the computer system. Assuming that the key received from the smart phone is successfully validated, then along with continuing other operations, e.g., file transfer, the computer system creates a new security key for association with the NFC tag, records that security key in its own memory system for the next transaction, and provides that security key to the smart phone. The smart phone, or more correctly, the virtual bucket app on the smart phone, expects the new key and when it is received from the computer system, it provides the key to the NFC tag. The NFC tag deletes the old security key and replaces it with the new security key. It is only a very short amount of time, e.g., at most one second—more likely one tenth of a second, for the validation to occur and the new key to be created, communicated and stored on the NFC tag. This is one method of dynamically changing the security keys at the NFC tag and at the computer system; however, the invention is not so limited as there are other approaches that can be used and achieve the same goal.

FIG. 5A1 shows the first stage of an exemplary dynamic secure close proximity tag identifier, e.g., NFC Tag identifier. The figure shows an NFC tag with the current unique identifier of ABCD. The server also has knowledge of this tags unique identifier. The unique identifier is used on the server to link a specific NFC tag to a specific virtual bucket running on the server. Both the server and the NFC tag are synchronized to have the same dynamically changing unique identifier. FIG. 5A1 shows that this unique identifier will be given to the First User NFC mobile communication device, by the NFC Tag, so that when the First User communicates to the Sever, it can transmit the unique identifier so as to instruct the virtual bucket system on the server which virtual bucket to access. The NFC Tag has a processor and memory. Running on that NFC tag can be an application or API, for dynamically generating a unique security identifier. This dynamic generation algorithm is also running in synchronous on the server.

In an exemplary approach, upon every use of the NFC Tag, the NFC tag will generate a new unique identifier. Based on the same algorithm running, separately, on each of the app and on the server, if the server receives a request containing the first unique identifier, at this point, it will process it, and at the same time generate a new unique identifier, based on the synchronized algorithm running on the NFC Tag. At the same time the NFC mobile communication device is reading the unique identifier, and while still communicating to the NFC Tag, the NFC mobile communication device is used as a conduit to receive confirmation from the server confirming that the unique identifier has been received. Once the confirmation is received by the application on the NFC Tag, the application generates a new unique identifier based on the synchronized algorithm.

FIG. 5A2 shows the same server and NFC Tag, but based on synchronization of the dynamic security identifier process, the NFC Tag now contains a new unique identifier, 11234. The server also has knowledge of this unique identifier and has linked the new unique identifier to the specific virtual bucket account defined for that specific NFC Tag.

This method of using a dynamic unique identifier can reduce the probability of an NFC Tag being cloned and remotely used, away from its proper physical placement. As well, the confirmation communication, where the server communicates via the NFC mobile communication device conduit, to the NFC Tags app, that it has received the unique identifier, reduces the security vulnerability of the NFC Tag identifier be generated and not synchronized with the information held on the server.

The NFC mobile communication device can also contain a unique security identifier or a secure credential to identify the NFC mobile communication device user as a valid user of the virtual bucket system, or an approved user allowed by User 1, to access User 1's virtual bucket. So the computer system can define which users are allowed to even request to access the virtual bucket system. The application to confirm credentials of the NFC mobile communication device User can run on an application running on the NFC Tags processor and memory as well as the server or computer system. The computer system can remotely communicate to the virtual bucket system on the NFC mobile communication device, post withdrawal, to remove or lock the information and/or files which the User 2 has just received from User 1's virtual bucket.

FIG. 5B shows a method of the new dynamic unique secure identifier of the NFC Tag, being generated by the server, and using the NFC mobile communication device, as a conduit to transmit a new unique identifier.

FIG. 5B1 shows an NFC mobile communication device of a First User, communicating to an NFC Tag with a unique Identifier ABCD.

FIG. 5B2 shows the NFC mobile communication device, while still communicating with the NFC Tag, begins communication with a server which has knowledge of that NFC Tags unique identifier ABCD.

FIG. 5B3 shows the server generating a new unique identifier for the specific NFC tag. This new unique identifier replaces the prior unique identifier for a specific virtual bucket account, defined to that NFC Tag. Therefore, virtual bucket account A was linked first by unique identifier ABCD. Now the server has generated a new unique identifier, 1234, which will be used by the Next NFC mobile communication device User, to access virtual bucket account A.

FIG. 5B4 shows the server with the newly generated unique identifier, 1234, using the NFC mobile communication device as a conduit, to communicate and encode unique identifier 1234, into the NFC Tag. The NFC Tag can contain an application or API, which can securely approve and/or confirm if that new unique identifier is being supplied by a valid server, computer system, or NFC Mobile device. This reduces opportunity for fraudulently encoding the wrong or malicious unique identifier onto the NFC Tag. The NFC Tag can also have a constant, read only unique identifier, which will work together with the dynamic unique identifier, to reduce opportunities of malicious encoding of the NFC Tag with a false or wrong unique dynamic secure identifier or to disrupt synchronization of unique identifiers between server and NFC Tag.

FIG. 5B5 shows the server and the NFC Tag, both containing the new server generated unique identifier for that NFC tag. The figure shows a Next User who can now interact with the NFC Tag and receive the new unique identifier. The process will be repeated with the new NFC mobile communication device user to generate yet another unique NFC Tag identifier to replace 1234. This allows for the server to generate more secure identifiers due to its more powerful processing power compared to the NFC Tag.

As such, dynamic identifiers are used during the transfer of information to increase the security of the system.

As we have become accustomed to forfeiture of personal information in our society, Virtual bucket can become the anonymous third party that is the middle man, but with a way that does not allow for that middle man to significantly hold, copy, or manipulate the information. The information is only stored for a very short period of time. In most cases, the data is stored for just a few seconds. Should a third party figure out a method for accessing and remove the information from the bucket, then at least the second party will, and possibly the first depending on the implementation, immediately know when it goes to retrieve the information from the bucket because the information will not be there.

Traditional methods of computing include standard features where a file can be created, deleted, copied, edited, or replaced. So a third party can sneak onto a first person's computer for example and right click, then copy and the person is never the wiser that a file has been accessed/modified/copied. This is not how the bucket system works. You can only place and then remove the file. It might seem against the grain of traditional computing, but it increases the security of a system running a virtual bucket system. The virtual bucket system increases security by only storing files for a short time (ideally), the virtual bucket's location in memory changes, and if a file is removed by a third party from the virtual bucket the location becomes empty and the second party immediately knows that there has been an access problem because there is no file to access.

For example, in an aspect if a third party is snooping in on a conversation between a first and second party, or tries accessing, editing, or replacing the file in the virtual bucket, that the computer system knows that something is happening there, and whatever you do to the file in the temporary bucket, will automatically delete it. Now you can try to take the file from the bucket, but you can't do anything more than that. you can only deposit or withdraw the file from the bucket and it's a onetime event for that file. So if some Chinese hacker is snooping in your bucket, whatever they do, will automatically initiate the bucket and thereby file from being destroyed. Now the good thing here is that when you try accessing the bucket, then you're told that the bucket is empty. This is a concept known as security awareness. Rather than trying to monitor and control files and communications, what we do is create it in such a way that the simple logic of the process makes the receivers proactive. Think about it for a second, human being are reactive creatures, so how do you make them proactive when it comes to security? By making it easy to understand that something is wrong, and then they can contact their IT person to look into the problem. If you have a company with 100,000 employees, I don't care how good your monitoring software is, or how talented your IT guy is, you're always playing catch up with the latest new vulnerability. But what if it was just spatial logic. That if something is there, then you get it, but if it's not there, then you know something is wrong. which is why when your phone scans the barcode on for example vbukit.com, if there is nothing there, your screen turns red and tells you bucket is empty. Now the first time this happens, maybe you think it's a server error. Second, time, it's a fluke. Third time you see your bucket is empty, you know something has gone wrong. When you get messages with the bucket system, you still get the e-mail, but when you try to open it, the message content is not there because the bucket was emptied so you know someone is snooping on you and thereby you make even the laziest employee proactive.

Because storage of the information is temporary, information is not held beyond it being provided to the second party. Once the information has been provided the computer system that maintains the virtual bucket deletes the data from the bucket and, in a preferred approach, the computer memory where the information was stored is over written, generally multiple times, thereby creating a greater increase in the ability to remove traceability and recreating of the transferred information, in any exchange of information.

Some of the significant advantages to using the virtual bucket invention are an ease of use, speedy implementation and use, anonymity between users, and security between users.

Standard interaction in the real world between two parties is narrowed to two common methods: verbal interaction and visual interaction. Verbal Interaction is the method of verbally informing or educating one or more parties. For example, person goes to a Dry Cleaner. They will speak what they wish to be done to their clothing. The employee will respond verbally as well. Visual Interaction is the method of visually informing or educating one or more parties. For example, a person returns to a Dry Cleaner to pick up their order. They will give an employee the claim ticket. This document has written or graphical information that will inform the employee as to what the first party being the customer, wishes.

In most every aspect of real world human interaction, human beings communicate with each other using verbal or visual interaction. While most technology such as kiosks or voice menus try continue the method of interaction based on verbal or visual, they remove the human interaction and require the technology to have intelligence that can interpret exactly what is being communicated. It is not uncommon that when a user uses a voice prompt system, the system does not comprehend/understand what the user has said. It is also not uncommon that when a user uses a touch screen on a computer system or kiosk system the system does not comprehend/understand what the user has indicated and results in the system accidentally ordering the wrong thing or performing an unintended operation due to a person accidentally touching the wrong button.

Virtual bucket is designed to provide some of the benefits, speed, and convenience of a real world technological interaction, but without having to completely remove the human element on both sides of the interaction. Rather, the system may depend on the human element on both sides of the interaction to more intelligently interpret what is being communicated.

For example, if a first party speaks to a second party, the second party can still understand the nuances of the first party's voice better than a machine when it comes to interpreting what the first party's is saying. While voice recognition has advanced greatly, it still has its limitations and as yet has not reach the level of quality and consistency that we have in human to human communication. The same is true for a kiosk. A kiosk can only deal with the variables that are defined to it. But if outside variables are introduced, another human being is more likely to understand and adapt to those outside variables, compared to a machine. For example, if first party's asks for something, but use a term for it that is not known to the machine or the human, the human is likely to analyze, expand the question, ask others around them, and more to discover what the term means and correlate it to one of the existing choices. A machine will simply tell the first party that it doesn't understand.

The human element is kept with Virtual bucket because the exchange of communication is digitized and processed in a manner that is more convenient than traditional means, and is still as reliable if not more reliable than current methods.

Additionally, virtual bucket does not generally require the second party, and in most applications, either party to learn any significantly new process for interaction. For example, the dry cleaner employee does not need to learn a new system. They use and continue to use the current system they have today in essentially the same way they do today, but they do it in a method that allows them to a more streamlined and beneficial way that enhances the current method. After the application of background software on a user's system, the Virtual bucket system provides the user with the ability with a new method of communicating to a third party computer system with a relatively quick curve for the user. Thus making the systems relatively easy to use by a new (or experienced) user.

The invention also provides an increased level of anonymity in transactions between computer systems. The virtual bucket system is designed such that no or significantly no relevant identifying information of a party is provided to the other party. Traditional methods of sending and receiving information generally require at least one if not both parties knowing at least some level or amount of identifying information about the other. With today having both business and government collecting and data mining every piece of information that consumer's provide, consumers are preferring using a communication technology which allows them the benefits of technology and information exchange without requiring that they provide some or any personal (to the computer or the user) information.

Today, consumers are more and more often having to give some or increasing amounts of personal, e.g., identifying, information to receive or process a transaction, information exchange, and more. The information being asked is information easily remembered such as a phone number or an e-mail address. But as more and more systems gather this information, it becomes easier for different data from different sources to correlate multiple data sources by combining the information which is linked by a single key identifier. For example, store A can have my purchasing habits and my loyalty program there might have a unique id, but is registered under my e-mail address. Store B can have a completely different loyalty system, with a completely different unique ID number, but uses my same core e-mail address. With just the e-mail address, they can now have a single mutual link to say that both data sources are based on data about a single individual.

Different from other communication systems where in order to communicate some identifying information is provided between systems, in this application the whole system is essentially anonymous. One could do many of these things today by e-mailing or texting that information to the consumer, but the consumer would have to give you that information. Instead, we use the virtual bucket as a very temporary holding area for people to interact anonymously to each other, in short range day to day interactions. Its instant, secure, allows complete anonymity, and nothing really changes or needs to be learned, except for the consumer to know they have to tap the counter with their phone rather than gabbing a receipt.

Security and anonymity are significant advantages to virtual bucket. The bucket itself being a temporary holding place means already that there is nothing to steal or monitor. Also defining a dynamic identifier where the user uses a specific identifier with a specific third parties virtual bucket, and that identifier is changed after use by the first user, so that the second user to use that same virtual bucket is now accessing a new unique identifier which the virtual bucket system knows and correlates to a specific permanent virtual bucket account. This means that information is not only temporarily stored, but the way and instruction of how to access the storage area is constantly changing. So the bucket ID for the first user cannot be reused by another user because once used, the dynamic bucket ID is changed to a new bucket ID. Limiting exposure time of the data, and dynamically changing the method of finding the storage location of that data dramatically reduces the liability that the data is to be stolen. The Dynamic Bucket ID can also change based on each unique piece of information or content that a sender sends to a receiver's device. For example, User A has a Smart TV with a browser, web app, or embedded application that can connect to the internet. This application broadcasts a barcode representing a dynamic bucket ID. User B has two pieces of content. A video and a document. User B links to the bucket and deposit the video content first. The dynamic bucket ID in this first use is 1234. Then when the video is done, User B wishes to show a document on User A's Smart TV. When depositing the second device, the system will automatically generate a new dynamic bucket ID where for example could be 9876. Every new interaction of deposit and withdrawal to the bucket will generate a new unique dynamic bucket ID.

A Virtual Bucket system can also increase privacy in transactions. The transfer of information by using a virtual bucket system, e.g., the action of depositing and withdrawing of information, although is repeatable, it is a one time action; which reduces privacy intrusions, e.g., reduces the likelihood that a third party can snoop For example, if a file is deposited in the virtual bucket and a third party attempts to to access the file in the bucket, then the bucket will be emptied. When the intended—the correct—receiving party tries to withdraw the file from the bucket, the party will become aware that the bucket empty, thus signifying that a security breach has occurred.

In a preferred approach, a virtual bucket system does not have the abilities for copy, edit, paste, replace, and/or delete the file being transferred from the first party to the second party, feature which traditional, conventional computing systems currently offer. Without these abilities, third parties have a reduced set of tools to acquire an original or copy of a file being transferred compared to traditional electronic communication methods for sending and receiving files. A unique file transferred using a virtual bucket in accordance with an exemplary approach of a virtual bucket system is a onetime deposit and one time withdraw. This approach may not completely prevent a criminal from taking the file, but it does increase the difficulty in taking the file and does provide substantially instant notification that the file has been taken. As such, if the second party did not take the file, then the parties are aware that a breach has happened shortly after it has occurred and thereby is able to take appropriate actions at a much earlier time and closer time to when the breach occurred.

For example, in when using a virtual bucket system with e-mail or file sharing, the delivery of the mail and any attachment(s) is different from conventional e-mail systems. When using a conventional e-mail system to send an e-mail from a sender's e-mail server to a receiver's e-mail server, while that e-mail might be sent immediately from the sender's e-mail server, the e-mail might stay in the receiver's e-mail server for hours or even days until that receiver synchronizes their e-mail client to download that email (and other e-mails) and possibly any attachments. A third party who has infected the receiver's e-mail server or has stolen the receiver's username and password can today, with ease, go into the e-mail and read it, and then mark it as unread. Unlike this flaw that exists in conventional computer systems, in a computer system using a virtual bucket system, the message and attachments are files, and if the file is deposited in a bucket instead of being placed in the receiver's ‘e-mail server, then if a third party does manage to hack in and views the message or attachments, these actions results in the virtual bucket system emptying out the bucket. So when the intended receiver subsequently to open or access that e-mail, then the intended receiver will find that the bucket is emptied, and can proactively start to correct a security breach right away.

So privacy can be better maintained because the two parties in a bucket deposit/withdraw transaction will generally be informed contemporaneously with the third party accessing the file and will be aware if some nefarious third party is snooping into their communication or downloading files that are not meant for them.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Furthermore, although aspects of the invention are described with respect to using NFC communications and NFC tags, the invention is not so limited and many of these aspects can be implemented using other systems. For example, RFID systems, barcodes, scan codes, 3D readers, QR codes, Bluetooth Low Energy BLE, ultrasonic sound beacons, and other type systems can be employed.

In an aspect, a dynamic bucket ID is associated and interpreted by a device receiving the dynamic bucket ID. Close proximity can be defined from point zero up to a few meters from the computing system. Technologies with communication methods of up to a few meters can include, Bluetooth, QR codes, ultrasonic, and other such communication technologies. Communication technologies communicating at point zero proximity can include bucket ID's embedded and read in a web url, text in the body of an e-mail or text via optical character recognition OCR, and other such zero point proximity communication methods. Between point zero and a few meters can include a variety of proximity technologies, such as NFC tags/readers, low power Bluetooth, and other such technologies. The invention should not be so limited to any specific communication technology that can transmit the dynamic bucket ID to the computer system receiving the dynamic bucket ID information.

For example, Zero point example, can include that the bucket ID information can be delivered to the computer system via e-mail, SMS, text message, web link, or other general transmission mediums. Once accessible on the computer device, if the bucket ID are characters on the screen, the proximity method of could be optical character recognition, where the OCR capabilities on the computer device can read the now local information of the bucket ID, and then use that information to connect to that specific bucket. This can also be a web link in that e-mail, that contains the bucket ID information in the url string. Once that information is within proximity of the computing device, it can be read and then used by the virtual bucket system on that computing device to communicate to the virtual bucket system that is being used to communicate via deposit and withdrawal of information with the computing device. It is the interpretation of the bucket ID on the device, that gives it the information to communicate to a specific bucket, to begin deposit and withdrawal of information between computing system. The invention should not be limited to any specific communication technology used to deliver the dynamic bucket ID.

Accordingly, the invention is not to be considered as limited by the foregoing description but is only limited by the scope of the claims.

What is claimed as new and desired to be protected by Letters Patent of the United States is:

1. A method for transferring an electronic data between a first computer system and a second computer system using a third computer system, comprising the steps of:
creating, by said third computer system, a temporary storage location in said third computer system;
creating, by said third computer system, a unique identifier associated with said temporary storage location;
associating, by said third computer system, said temporary storage location with said first computer system;
reading, by said second computer system, using a first communication method a communication information from a close proximity identification medium; and
using, by said second computer system, at least a part of said communication information to establish communications using a second communication method with said third computer system.

2. The method of claim 1, further comprising the steps of:
reading, by said second computer system, access information from said close proximity identification medium;
reading, by said second computer system, a first security key from said close proximity identification medium;
using, by said second computer system, at least a part of said access information to access said third computer system;
and determining by said third computer system validity of said first security key.

3. The method of claim 2, further comprising the steps of:
providing, by said first computer system, to third computer system a data to be stored in said temporary storage location;
receiving, by said third computer system, said data;
determining, by said third computer system, said temporary storage location associated with first computer system;
storing, by said third computer system, said data in said temporary storage location;
requesting, by said second computer system, a stored data;
determining, by said third computer system, said temporary storage location based on at least part of said access information;
creating, by said third computer system, a subsequent security key;
providing, by said third computer system, said data in said temporary storage location, to said second computer system; and
providing, by said second computer system, said subsequent security key to said first computer system.

4. The method of claim 2, further comprising the steps of:
providing, by said second computer system, to third computer system a second data to be stored in said temporary storage location;
receiving, by said third computer system, said second data;
determining, by said third computer system, said temporary storage location based on at least part of said access information; and
storing, by said third computer system, said second data in said temporary storage location;
requesting, by said first computer system, said second stored data;
determining, by said third computer system, said temporary storage location associated with first computer system; and
providing, by said third computer system, said second data in said temporary storage location, to said first computer system.

5. The method of claim 3, further comprising the steps of:
providing, by said second computer system, to third computer system a second data to be stored in said temporary storage location;
receiving, by said third computer system, said second data;
determining, by said third computer system, said temporary storage location based on at least part of said access information; and
storing, by said third computer system, said second data in said temporary storage location;
requesting, by said first computer system, said second stored data;
determining, by said third computer system, said temporary storage location associated with first computer system; and
providing, by said third computer system, said second data in said temporary storage location, to said first computer system.

6. The method of claim 2, wherein said first communication method is a close proximity communication method.

7. The method of claim 6, wherein said close proximity communication method is a near field communication method.

8. The method of claim 1, further comprising the steps of:
deleting by said first computer system said data on said second computer system.

9. The method of claim 3, further comprising the steps of:
deleting, by said third computer system, said temporary storage location in said third computer system;
deleting, by said third computer system, said unique identifier associated with said temporary storage location;
creating, by said third computer system, a second temporary storage location in said third computer system;
creating, by said third computer system, a second unique identifier associated with said temporary storage location; and
associating, by said third computer system, said second temporary storage location with said first computer system.

10. The method of using a temporary storage location on a server to transfer data between a first computing system and a second computing system, said method being operable in a first mode, comprising the steps of:
creating a temporary storage location associated with said first computing system;
creating an identification code for said temporary storage location;
sending by said first computing system data to said server to be stored by said server;
determining by said server a temporary storage location associated with said first computing system;
storing said data in said temporary storage location associated with said first computing system;
receiving from a close proximity identification medium by said second computing system a unique identifier for said close proximity identification medium;
receiving from said close proximity identification medium by said second computing system a communication information;
receiving from said close proximity identification medium by said second computing system a security key;
communicating by said second computing system with said server based on said communication information;
validating said security key by said server; and
providing by said second computing system to said server said unique identifier for said close proximity identification medium.

11. The method of claim 10, further comprising the steps of:
determining by said server a temporary storage location associated with said unique identifier for said close proximity identification medium; and
providing to said second computing system said data from said temporary storage location if said unique identifier for said close proximity identification medium corresponds to said identification code for said temporary storage location.

12. The method of claim 11, further comprising the steps of:
deleting said temporary storage location associated with said first computing system; and
deleting said identification code for said temporary storage location.

13. The method of claim 12, wherein said method being operable in a second mode, comprising the steps of:
creating a second temporary storage location associated with said first computing system;
creating a second identification code for said second temporary storage location;
receiving from said close proximity identification medium by said second computing system a second unique identifier for said close proximity identification medium, where said second unique identifier corresponds to said second identification code;
receiving from said close proximity identification medium by said second computing system a second communication information;
communicating by said second computing system with said server based on said second communication information;
providing by said second computing system to said server said second unique identifier for said close proximity identification medium;
determining by said server said second temporary storage location based on said second unique identifier; and
storing said second data in said second temporary storage location;

14. The method of claim 13, further comprising the step of:
providing to said first computing system said data from said second temporary storage location.

15. The method of claim 14, further comprising the steps of:
deleting said second temporary storage location;
deleting said second identification code for said second temporary storage location;
creating a third temporary storage location associated with said first computing system; and
creating a third identification code for said third temporary storage location.

16. The method of using a temporary storage location to transfer electronic data between a first computing system and a second computing system, comprising the steps of:
creating, by a third computing system, a temporary storage location on said third computing system, said storage location being associated with said first computing system;
creating, by said third computing system, a temporary identification code associated with said temporary storage location on said third computing system;
creating, by said third computing system, a security code associated with said temporary storage location on said third computing system;
reading, by said second computing system, an identification associated with said storage location from a close proximity identification medium;
reading, by said second computing system, a close proximity security code associated with said storage location from a close proximity identification medium;
sending data, by one of said first and second computing systems, to said third computing system;
validating by said third computing system, said security code with said close proximity security code;
determining, by said third computing system, a determined storage location;
storing, by said third computing system, data in said determined storage location;
receiving, by the other of said first and second computing systems, data from said determined storage location;
deleting said temporary identification code; and
deleting said determined storage location.

17. The method of claim 16, wherein said step of determining, by said third computing system, a determined storage location further comprises the steps of:
in the case of said first computing device being said one of said first and second computing systems, said third computing device determines said determined storage location being said storage location being associated with said first computing system; and
in the case of said second computing device being said one of said first and second computing systems, said third computing device determines said determined storage location being said storage location based on said identification associated with said storage location from said close proximity identification medium.

18. The method of claim 16, wherein said second computing system is a mobile communication device.

19. The method of claim 16, further comprising the step of:
deleting by said first computer system said data on said second computer system.

20. The method of claim 16, further comprising the steps of
creating, by said third computing system, a second temporary storage location on said third computing system, said storage location being associated with said first computing system; and
creating, by said third computing system, a temporary identification code associated with said temporary storage location on said third computing system.
